(19) United States
(12) Patent Application Publication
(10) Pub. No.: US 2020/0181492 A1
(43) Pub. Date: Jun. 11, 2020

(54) LIQUID CRYSTAL MEDIUM AND LIQUID CRYSTAL DEVICE

(71) Applicant: MERCK PATENT GMBH, DARMSTADT (DE)

(72) Inventor: Simon SIEMIANOWSKI, Darmstadt (DE)

(73) Assignee: MERCK PATENT GMBH, DARMSTADT (DE)

(21) Appl. No.: 16/333,455

(22) PCT Filed: Sep. 11, 2017
(86) PCT No.: PCT/EP2017/072674

§ 371 Date: Mar. 14, 2019

(30) Foreign Application Priority Data
Sep. 14, 2016 (EP) 16188677.5

(51) Int. Cl. C09K 19/30; C09K 19/02

(52) U.S. Cl. CPC C09K 19/3028; C09K 19/0258; C09K 19/3003; C09K 19/3068; C09K 2019/301; C09K 2019/3006; C09K 2019/3016; C09K 2019/3018; C09K 2019/3013

(57) ABSTRACT

The invention relates to a medium comprising one or more compounds of formula I,

R¹¹-A¹¹-A¹²-(CH₂)ₛ-A¹³-A¹⁴-R¹² I

in a concentration of up to 30% or less,
and one or more compounds of formula II,

R²¹-A²¹-A²²-(A²³)ᵤ-Z²¹—(CH₂)ₜ—Z²²-A²⁴-A²⁵-A²⁶-R²² II

in a concentration of 10% or more,
wherein R¹¹ to R²², A¹¹ to A²⁶, Z²¹, Z²², s, t, and u have one of the meanings as given in claim 1, to a method of production of such a media, to the use of such media in liquid crystal devices, in particular in flexoelectric liquid crystal devices, and to a flexoelectric liquid crystal device comprising a medium according to the present invention.

The invention relates to a medium comprising one or more compounds of formula I,

R¹¹-A¹¹-A¹²-(CH₂)ₛ-A¹³-A¹⁴-R¹² I

in a concentration of up to 30% or less,
and one or more compounds of formula II,

R²¹-A²¹-A²²-(A²³)ᵤ-Z²¹—(CH₂)ₜ—Z²²-A²⁴-A²⁵-A²⁶-R²² II

in a concentration of 10% or more,
wherein R¹¹ to R²², A¹¹ to A²⁶, Z²¹, Z²², s, t, and u have one of the meanings as given herein below, to a method of production of such a media, to the use of such media in liquid crystal devices, in particular in flexoelectric liquid crystal devices, and to a flexoelectric liquid crystal device comprising a medium according to the present invention.

### Background and Prior Art

The flexoelectric effect is described, for example, by Chandrasekhar, “Liquid Crystals”, 2nd edition, Cambridge University Press (1992) and P. G. deGennes et al., “The Physics of Liquid Crystals”, 2nd edition, Oxford Science Publications (1995).

Flexoelectric devices utilizing the flexoelectric effect and Liquid crystal media that are especially suitable for flexoelectric devices and are known from EP 0 971 016, GB 2 356 629 and Coles, H. J., Musgrave, B., Coles, M. J., and Willmott, J., J. Mater. Chem., 11, p. 2709-2716 (2001).

In addition to these compositions also LC media are known, for example from WO 2013/004333 A1 or WO 2013/174481 A1, which exhibit in addition to the conventional nematic phase an additional second nematic phase. This separate nematic phase is also known as the twist bend nematic phase (N_{TB}) and is exclusive to bent core or bimesogenic compounds having very low bend elastic constant (k₃₃) values.

The elucidation of the N_{TB} phase has a lot of interest from academia such as for example disclosed by Luckhurst et al. in J. Mat Chem. 2011, 21, 12303-12308, or Luckhurst et al. J. Phys. Chem. B, 2013, 117 (21), pp 6547-6557 or Selinger Phys. Rev. E 87, 52503.

However, as of yet, there are no stable media that exhibit the N_{TB} phase at room temperature or even exhibit a good stability against crystallisation. Accordingly, there is a great demand for new LC media, which exhibit, preferably at the same time:
a favourable broad N_{T}e phase from above room temperature down to low temperatures,
a favourable stability against crystallisation in the bulk as well in LC cells, especially at lower temperatures.

In addition to those requirements, the LC media should exhibit low melting points, broad chiral nematic phase ranges, short temperature independent pitch lengths and high flexoelectric coefficients. Other aims of the present invention are immediately evident to the person skilled in the art from the following detailed description.

Surprisingly, the inventors have found out that the one or more of the above-mentioned aims can be achieved by providing a medium according to claim 1.

In particular, the LC media in accordance with the present invention are favourable stable in cells and in the bulk at room temperature. At the same time, the media exhibit broad twist-bend nematic (Nm) phase from above room temperature down to low temperatures.

### Terms and Definitions

The term “liquid crystal”, “mesomorphic compound”, or “mesogenic compound” (also shortly referred to as “mesogen”) means a compound that under suitable conditions of temperature, pressure and concentration can exist as a mesophase (nematic, smectic, etc.) or in particular as a LC phase. Non-amphiphilic mesogenic compounds comprise for example one or more calamitic, banana-shaped or discotic mesogenic groups.

The term “mesogenic group” means in this context, a group with the ability to induce liquid crystal (LC) phase behaviour. The compounds comprising mesogenic groups do not necessarily have to exhibit an LC phase themselves. It is also possible that they show LC phase behaviour only in mixtures with other compounds. For the sake of simplicity, the term “liquid crystal” is used hereinafter for both mesogenic and LC materials.

Throughout the application, unless stated explicitly otherwise, the term “aryl and heteroaryl groups” encompass groups, which can be monocyclic or polycyclic, i.e. they can have one ring (such as, for example, phenyl) or two or more rings, which may also be fused (such as, for example, naphthyl) or covalently linked (such as, for example, biphenyl), or contain a combination of fused and linked rings.

Heteroaryl groups contain one or more heteroatoms, preferably selected from O, N, S and Se. Particular preference is given to mono-, bi- or tricyclic aryl groups having 6 to 25 C atoms and mono-, bi- or tricyclic heteroaryl groups having 2 to 25 C atoms, which optionally contain fused rings, and which are optionally substituted. Preference is furthermore given to 5, 6 or 7-membered aryl and heteroaryl groups, in which, in addition, one or more CH groups may be replaced by N, S or O in such a way that O atoms and/or S atoms are not linked directly to one another. Preferred aryl groups are, for example, phenyl, biphenyl, terphenyl, [1,1′:3′,1″]terphenyl-2′-yl, naphthyl, anthracene, binaphthyl, phenanthrene, pyrene, dihydropyrene, chrysene, perylene, tetracene, pentacene, benzopyrene, fluorene, indene, indenofluorene, spirobifluorene, more preferably 1,4-phenylene, 4,4′-biphenylene, 1,4-tephenylene.

Preferred heteroaryl groups are, for example, 5 membered rings, such as pyrrole, pyrazole, imidazole, 1,2,3-triazole, 1,2,4-triazole, tetrazole, furan, thiophene, selenophene, oxazole, isoxazole, 1,2 thiazole, 1,3-thiazole, 1,2,3-oxadiazole, 1,2,4 oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 6 membered rings, such as pyridine, pyridazine, pyrimidine, pyrazine, 1,3,5-triazine, 1,2,4-triazine, 1,2,3-triazine, 1,2,4,5-tetrazine, 1,2,3,4-tetrazine, 1,2,3,5-tetrazine, or condensed groups, such as indole, iso-indole, indolizine, indazole, benzimidazole, benzotriazole, purine, naphth-imidazole, phenanthrimidazole, pyridimidazole, pyrazinimidazole, quinoxalinimidazole, benzoxazole, naphthoxazole, anthroxazole, phen-anthroxazole, isoxazole, benzothiazole, benzofuran, isobenzofuran, dibenzofuran, quinoline, isoquinoline, pteridine, benzo-5,6-quinoline, benzo-6,7-quino-line, benzo-7,8-quinoline, benzoisoquinoline, acridine, phenothiazine, phenoxazine, benzopyridazine, benzopyrimidine, quinoxaline, phenazine, naphthyridine, azacarbazole, benzocarboline, phenanthridine, phenanthroline, thieno[2,3b]thiophene, thieno[3,2b]-thiophene, dithienothiophene, isobenzothiophene, dibenzothiophene, benzothiadiazothiophene, or combinations of these groups. The heteroaryl groups may also be substituted by alkyl, alkoxy, thioalkyl, fluorine, fluoroalkyl or further aryl or heteroaryl groups.

In the context of this application, the term “(non-aromatic) alicyclic and heterocyclic groups” encompass both saturated rings, i.e. those that contain exclusively single bonds, and partially unsaturated rings, i.e. those that may also contain multiple bonds. Heterocyclic rings contain one or more heteroatoms, preferably selected from Si, O, N, S and Se. The (non-aromatic) alicyclic and heterocyclic groups can be monocyclic, i.e. contain only one ring (such as, for example, cyclohexane), or polycyclic, i.e. contain a plurality of rings (such as, for example, decahydro-naphthalene or bicyclooctane). Particular preference is given to saturated groups.

Preference is furthermore given to mono-, bi- or tricyclic groups having 3 to 25 C atoms, which optionally contain fused rings and that are optionally substituted. Preference is furthermore given to 5-, 6-, 7- or 8-membered carbocyclic groups in which, in addition, one or more C atoms may be replaced by Si and/or one or more CH groups may be replaced by N and/or one or more non-adjacent CH2 groups may be replaced by —O— and/or —S—. Preferred alicyclic and heterocyclic groups are, for example, 5-membered groups, such as cyclopentane, tetrahydrofuran, tetrahydrothiofuran, pyrrolidine, 6-membered groups, such as cyclohexane, silinane, cyclohexene, tetrahydropyran, tetrahydrothiopyran, 1,3-dioxane, 1,3-dithiane, piperidine, 7-membered groups, such as cycloheptane, and fused groups, such as tetrahydronaphthalene, decahydronaphthalene, indane, bicyclo[1.1.1]-ipentane-1,3-diyl, bicyclo[2.2.2]octane-1,4-diyl, spiro[3.3]heptane-2,6-diyl, octahydro-4,7-methanoindane-2,5-diyl, more preferably 1,4-cyclohexylene 4,4′-bicyclohexylene, 3,17-hexadecahydro-cyclopenta[a]phenanthrene, optionally being substituted by one or more identical or different groups L. Especially preferred aryl-, heteroaryl-, alicyclic- and heterocyclic groups are 1,4-phenylene, 4,4′-biphenylene, 1,4-terphenylene, 1,4-cyclohexylene, 4,4′-bicyclohexylene, and 3,17-hexadecahydro-cyclopenta[a]-phenanthrene, optionally being substituted by one or more identical or different groups L.

Preferred substituents of the above-mentioned aryl-, heteroaryl-, alicyclic- and heterocyclic groups (L) are, for example, solubility-promoting groups, such as alkyl or alkoxy and electron-withdrawing groups, such as fluorine, nitro or nitrile.

Particularly preferred substituents are, for example, halogen, CN, NO2, CH3, C2H5, OCH3, OC2H5, COCH3, COC2H5, COOCH3, COOC2H5, CF3, OCF3, OCHF2 or OC2F5.

Above and below “halogen” denotes F, Cl, Br or I.

Above and below, the terms “alkyl”, “aryl”, “heteroaryl”, etc., also encompass polyvalent groups, for example alkylene, arylene, heteroarylene, etc.

The term “aryl” denotes an aromatic carbon group or a group derived there from.

The term “heteroaryl” denotes “aryl” in accordance with the above definition containing one or more heteroatoms.

Preferred alkyl groups are, for example, methyl, ethyl, n propyl, isopropyl, n butyl, isobutyl, s butyl, t butyl, 2 methylbutyl, n pentyl, s pentyl, cyclo-pentyl, n hexyl, cyclohexyl, 2 ethylhexyl, n heptyl, cycloheptyl, n octyl, cyclooctyl, n nonyl, n decyl, n undecyl, n dodecyl, dodecanyl, trifluoro-methyl, perfluoro-n-butyl, 2,2,2-trifluoroethyl, perfluorooctyl, perfluoro-hexyl, etc.

Preferred alkoxy groups are, for example, methoxy, ethoxy, 2-methoxy-ethoxy, n-propoxy, i-propoxy, n-butoxy, i-butoxy, s-butoxy, t-butoxy, 2-methylbutoxy, n-pentoxy, n-hexoxy, n-heptoxy, n-octoxy, n-nonoxy, n-decoxy, n-undecoxy, n-dodecoxy.

Preferred alkenyl groups are, for example, ethenyl, propenyl, butenyl, pentenyl, cyclopentenyl, hexenyl, cyclohexenyl, heptenyl, cycloheptenyl, octenyl, cyclooctenyl.

Preferred alkynyl groups are, for example, ethynyl, propynyl, butynyl, pen-tynyl, hexynyl, octynyl.

Preferred amino groups are, for example, dimethylamino, methylamino, methylphenylamino, phenylamino.

The term “chiral” in general is used to describe an object that is non-superimposable on its mirror image.

“Achiral” (non-chiral) objects are objects that are identical to their mirror image.

The terms “chiral nematic” and “cholesteric” are used synonymously in this application, unless explicitly stated otherwise.

The term “bimesogenic compound” relates to compounds comprising two mesogenic groups in the molecule. Just like normal mesogens, they can form many mesophases, depending on their structure. In particular, bimesogenic compound may induce a second nematic phase, when added to a nematic liquid crystal medium. Bimesogenic compounds are also known as “dimeric liquid crystals”.

The term “director” is known in prior art and means the preferred orientation direction of the long molecular axes (in case of calamitic compounds) or short molecular axes (in case of discotic compounds) of the liquid-crystalline molecules. In case of uniaxial ordering of such anisotropic molecules, the director is the axis of anisotropy.

The term “alignment” or “orientation” relates to alignment (orientation ordering) of anisotropic units of material such as small molecules or fragments of big molecules in a common direction named “alignment direction”. In an aligned layer of liquid-crystalline material, the liquid-crystalline director coincides with the alignment direction so that the alignment direction corresponds to the direction of the anisotropy axis of the material.

The term “planar orientation/alignment”, for example in a layer of an liquid-crystalline material, means that the long molecular axes (in case of calamitic compounds) or the short molecular axes (in case of discotic compounds) of a proportion of the liquid-crystalline molecules are oriented substantially parallel (about 180°) to the plane of the layer.

The term “homeotropic orientation/alignment”, for example in a layer of a liquid-crystalline material, means that the long molecular axes (in case of calamitic compounds) or the short molecular axes (in case of discotic compounds) of a proportion of the liquid-crystalline molecules are oriented at an angle θ (“tilt angle”) between about 80° to 90° relative to the plane of the layer.

The terms “uniform orientation” or “uniform alignment” of an liquid-crystalline material, for example in a layer of the material, mean that the long molecular axes (in case of calamitic compounds) or the short molecular axes (in case of discotic compounds) of the liquid-crystalline molecules are oriented substantially in the same direction. In other words, the lines of liquid-crystalline director are parallel.

The wavelength of light generally referred to in this application is 550 nm, unless explicitly specified otherwise.

The birefringence Δn herein is defined by the following equation

Δn=nₑ−nₒ

wherein nₑ is the extraordinary refractive index and nₒ is the ordinary refractive index, and the average refractive index n_{av.} is given by the following equation

n_{av.}=[(2nₒ²+nₑ2)/3]^{1/2}

The extraordinary refractive index nₑ and the ordinary refractive index no can be measured using an Abbe refractometer.

In the present application the term “dielectrically positive” is used for compounds or components with Δε>3.0, “dielectrically neutral” with −1.5≤Δε≤3.0 and “dielectrically negative” with Δε<−1.5. Δε is determined at a frequency of 1 kHz and at 20° C. The dielectric anisotropy of the respective compound is determined from the results of a solution of 10% of the respective individual compound in a nematic host mixture. In case the solubility of the respective compound in the host medium is less than 10% its concentration is reduced by a factor of 2 until the resultant medium is stable enough at least to allow the determination of its properties. Preferably, the concentration is kept at least at 5%, however, in order to keep the significance of the results a high as possible. The capacitance of the test mixtures are determined both in a cell with homeotropic and with homogeneous alignment. The cell gap of both types of cells is approximately 20 μm. The voltage applied is a rectangular wave with a frequency of 1 kHz and a root mean square value typically of 0.5 V to 1.0 V; however, it is always selected to be below the capacitive threshold of the respective test mixture.

Δε is defined as (ε∥−ε⊥), whereas ε_{av.} is (ε∥+2ε⊥)/3. The dielectric permittivity of the compounds is determined from the change of the respective values of a host medium upon addition of the compounds of interest. The values are extrapolated to a concentration of the compounds of interest of 100%. A typical host medium is ZLI-4792 or BL-087 both commercially available from Merck, Darmstadt.

For the present invention,

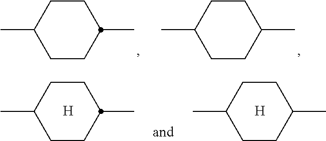

denote 1,4-cyclohexylene, preferably in trans-configuration, and

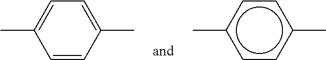

denote 1,4-phenylene.

The term “room temperature” or RT denotes 21° C.

Furthermore, the definitions as given in C. Tschierske, G. Pelzl and S. Diele, Angew. Chem. 2004, 116, 6340-6368 shall apply to non-defined terms related to liquid crystal materials in the instant application.

### DETAILED DESCRIPTION

The invention relates to a medium comprising one or more compounds of formula I,

R¹¹-A¹¹-A¹²-(CH₂)ₛ-A¹³-A¹⁴-R¹² I

in a concentration of up to 30% or less
and one or more compounds of formula II,

R²¹-A²¹-A²²-(A²³)ᵤ-Z²¹—(CH₂)ₜ—Z²²-A²⁴-A²⁵-A²⁶-R²² II

in a concentration of 10% or more,
wherein
R¹¹ to R²² are each independently H, F, Cl, CN, NCS or a straight-chain or branched alkyl group, which may be unsubstituted, mono- or polysubstituted by halogen or CN, it being also possible for one or more non-adjacent CH₂ groups to be replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another,
   preferably F, Cl, CN, a straight-chain or branched alkyl or alkoxy group which may be unsubstituted, mono- or polysubstituted by halogen or CN, more preferably F, CN, or OCF₃,
A¹¹ to A²⁶ are each independently in each occurrence 1,4-phenylene, wherein in addition one or more CH groups may be replaced by N, trans-1,4-cyclo-hexylene in which, in addition, one or two non-adjacent CH₂ groups may be replaced by O and/or S, 1,4-cyclohexenylene, 1,4-bicyclo-(2,2,2)-octylene, piperidine-1,4-diyl, naphthalene-2,6-diyl, decahydro-naphthalene-2,6-diyl, 1,2,3,4-tetrahydro-naphthalene-2,6-diyl, cyclobutane-1,3-diyl, spiro[3.3]heptane-2,6-diyl or dispiro[3.1.3.1]decane-2,8-diyl, it being possible for all these groups to be unsubstituted, mono-, di-, tri- or tetrasubstituted with F, Cl, CN or alkyl, alkoxy, alkylcarbonyl or alkoxycarbonyl groups, wherein one or more H atoms may be substituted by F or Cl, preferably each independently in each occurrence 1,4-phenylene, wherein in addition one or more CH groups may be replaced by N, or trans-1,4-cyclo-hexylene in which, in addition, one or two non-adjacent CH₂ groups may be replaced by O and/or S, it being possible for both ring groups to be unsubstituted, mono-, di-, tri- or tetrasubstituted with F, Cl, CN or alkyl, alkoxy, alkylcarbonyl or alkoxycarbonyl groups, wherein one or more H atoms may be substituted by F or Cl,
Z²¹ and Z²² are each independently in each occurrence, —COO—, —OCO—, —O—CO—O—, —OCH₂—, —CH₂O—, —OCF₂—, —CF₂O—, —CH₂CH₂—, —(CH₂)₄—, —CF₂CF₂—, —CH═CH—, —CF═CF—, —CH═CH—COO—, —OCO—CH═CH— or —C≡C—, optionally substituted with one or more of F, S and/or Si, preferably —COO—, —OCO—, or —O—CO—O—, more preferably —COO—, or —OCO—,
s and t denotes an integer from 1 to 15, preferably an odd (i.e. uneven) integer and, more preferably 3, 5, 7 or 9, and
u denotes 0 or 1,
   preferably 0.

Preferred compounds of formula I are selected from compounds in which the groups (-A¹¹-A¹²-) and (-A¹³-A¹⁴-) are each and independently selected from the following groups

| | |
|---|---|
| -Phe-Phe- | MG-1 |
| -Phe-Cyc- | MG-2 |
| -PheL-PheL- | MG-3 |
| -Phe-PheL- | MG-4 |
| -PheL-Phe- | MG-5 |
| -PheL-Cyc- | MG-6 |
| -Cyc-PheL- | MG-7 |
| -Cyc-Cyc- | MG-8 |

### Wherein,

Phe in these groups is 1,4-phenylene,
PheL is a 1,4-phenylene group which is substituted by 1 to 4 groups L, with L being preferably F, Cl, CN, OH, NO₂ or an optionally fluorinated alkyl, alkoxy or alkanoyl group with 1 to 7 C atoms, very preferably F, Cl, CN, OH, NO₂, CH₃, C₂H₅, OCH₃, OC₂H₅, COCH₃, COC₂H₅, COOCH₃, COOC₂H₅, CF₃, OCF₃, OCHF₂, OC₂F₅, in particular F, Cl, CN, CH₃, C₂H₅, OCH₃, COCH₃ and OCF₃, most preferably F, Cl, CH₃, OCH₃ and COCH₃ and
Cyc is 1,4-cyclohexylene.

Preferred are compounds of formula I wherein (-A¹¹-A¹²-) and (-A¹³-A¹⁴-) in formula I are identical or mirror images.

In addition, compounds of formula I containing an achiral branched group R¹¹ and/or R¹² may occasionally be of importance, for example, due to a reduction in the tendency towards crystallisation. Branched groups of this type generally do not contain more than one chain branch. Preferred achiral branched groups are isopropyl, isobutyl (=methylpropyl), isopentyl (=3-methylbutyl), isopropoxy, 2-methyl-propoxy and 3-methylbutoxy.

Especially preferred compounds of formula I are selected from the group of compounds of the following formulae,

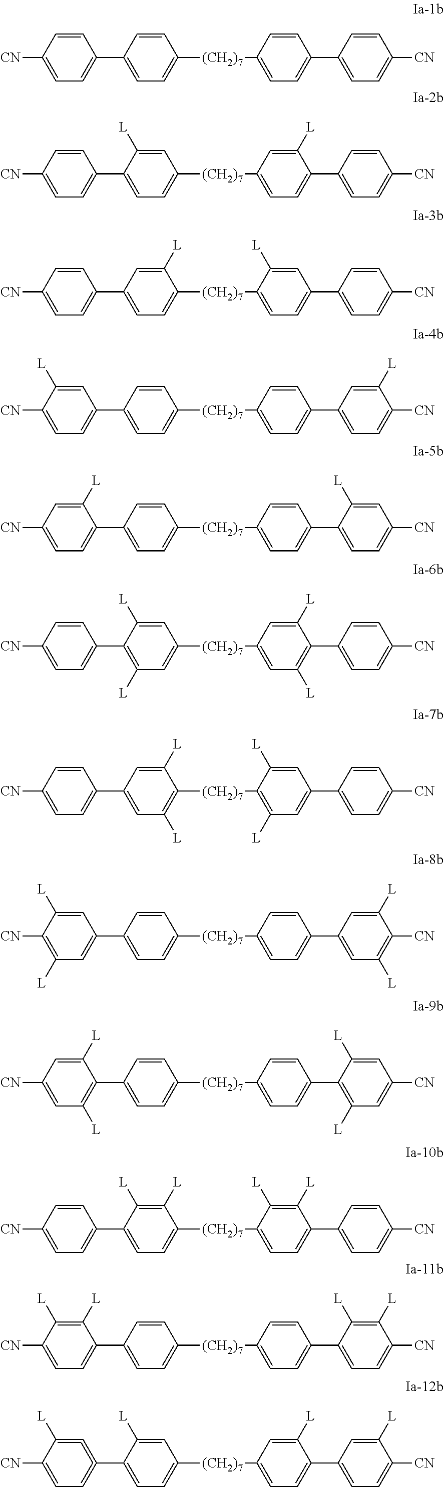

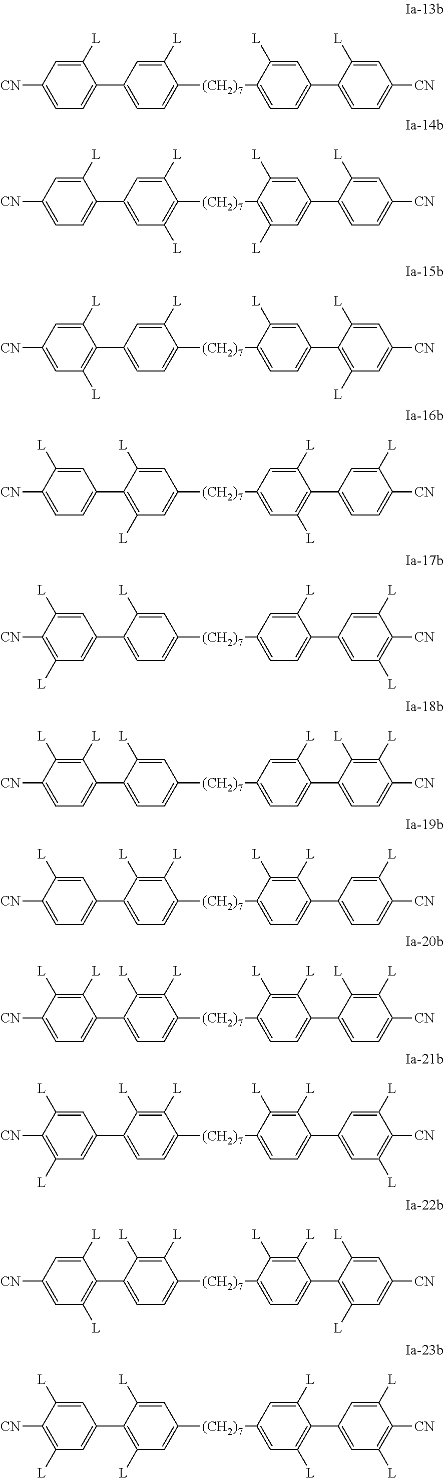

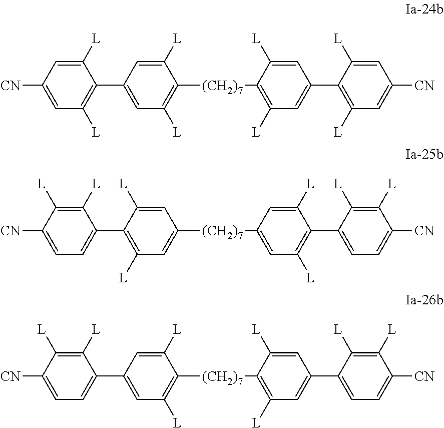

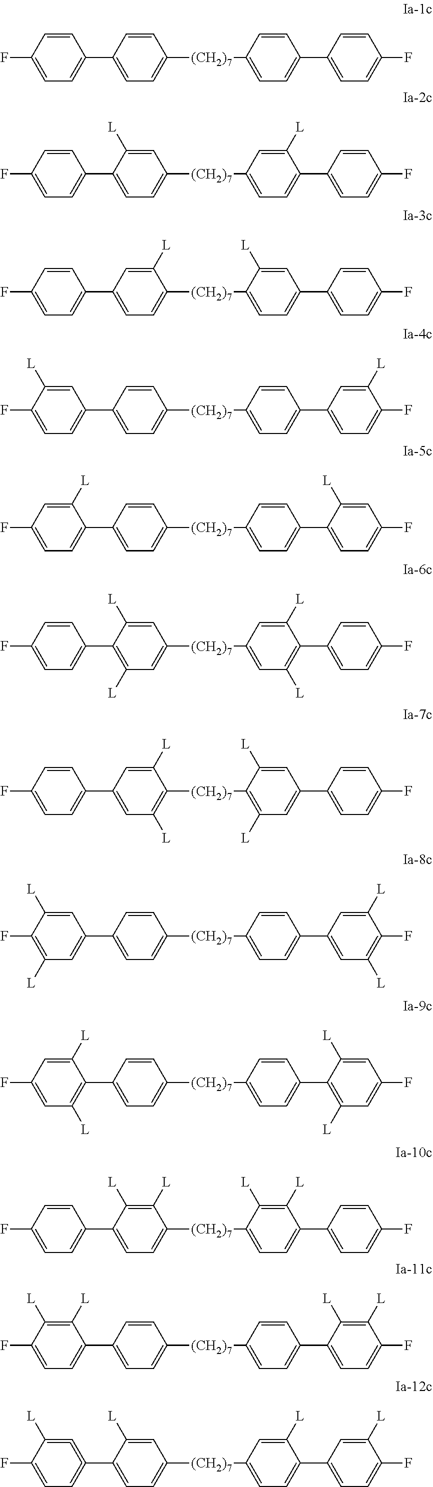

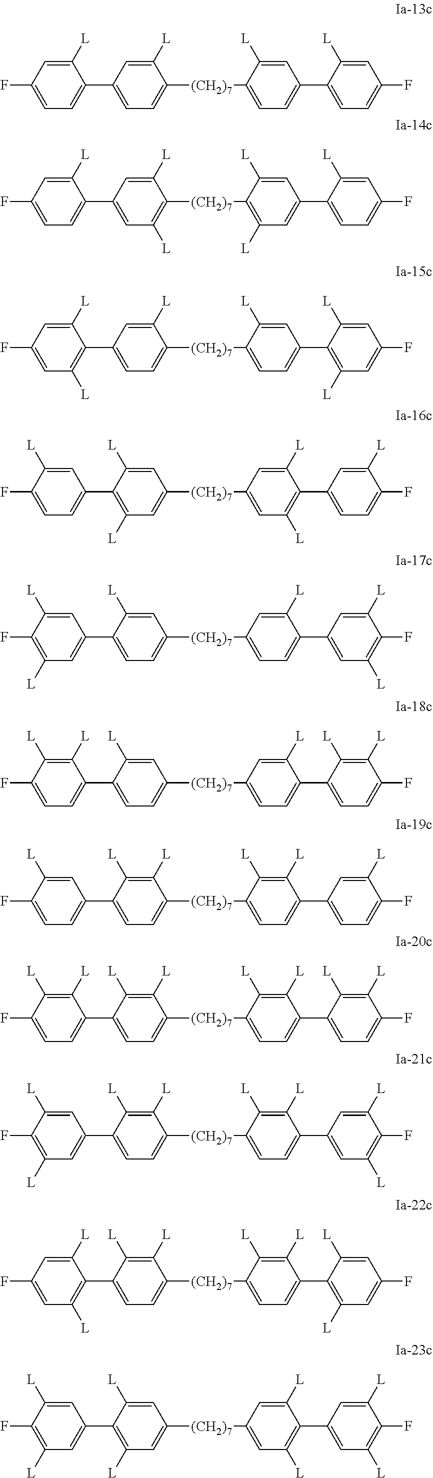

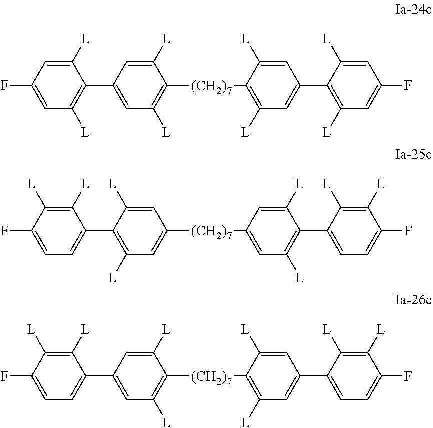

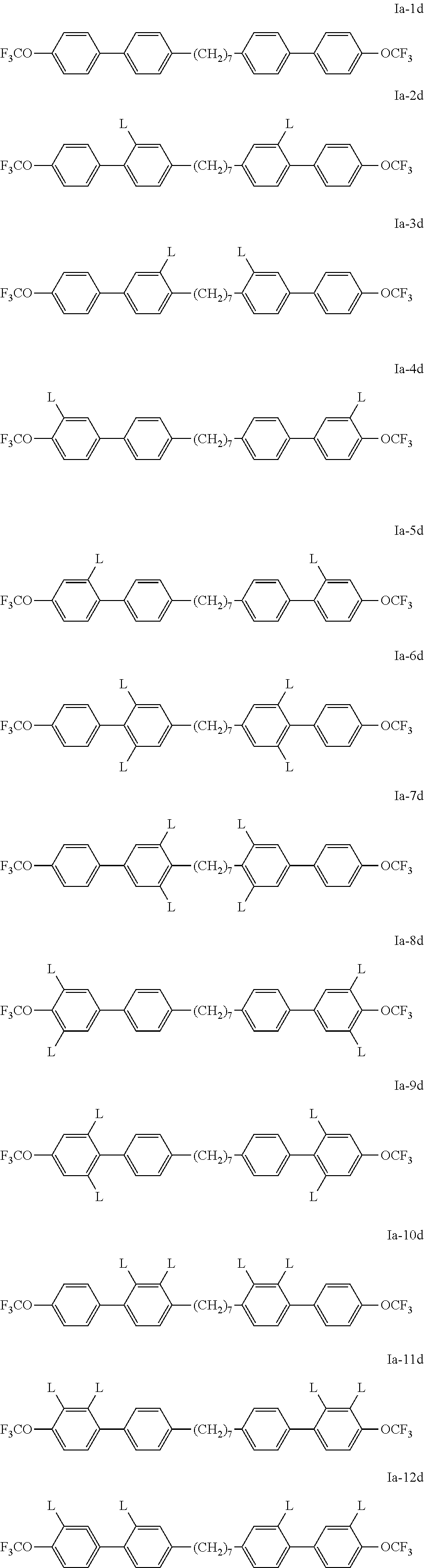

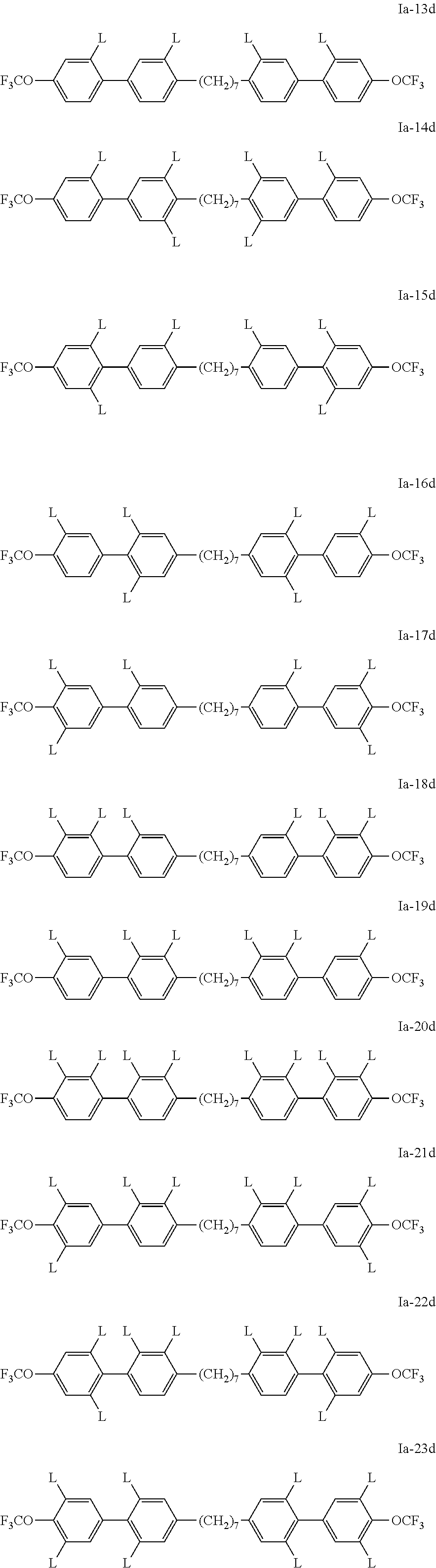

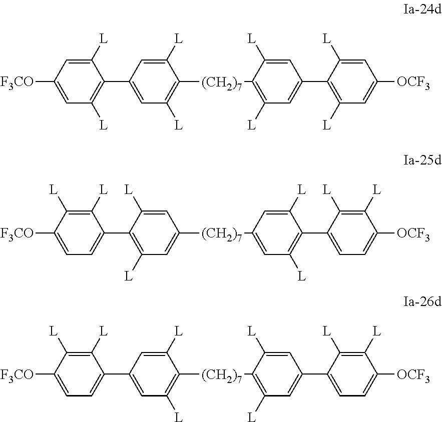

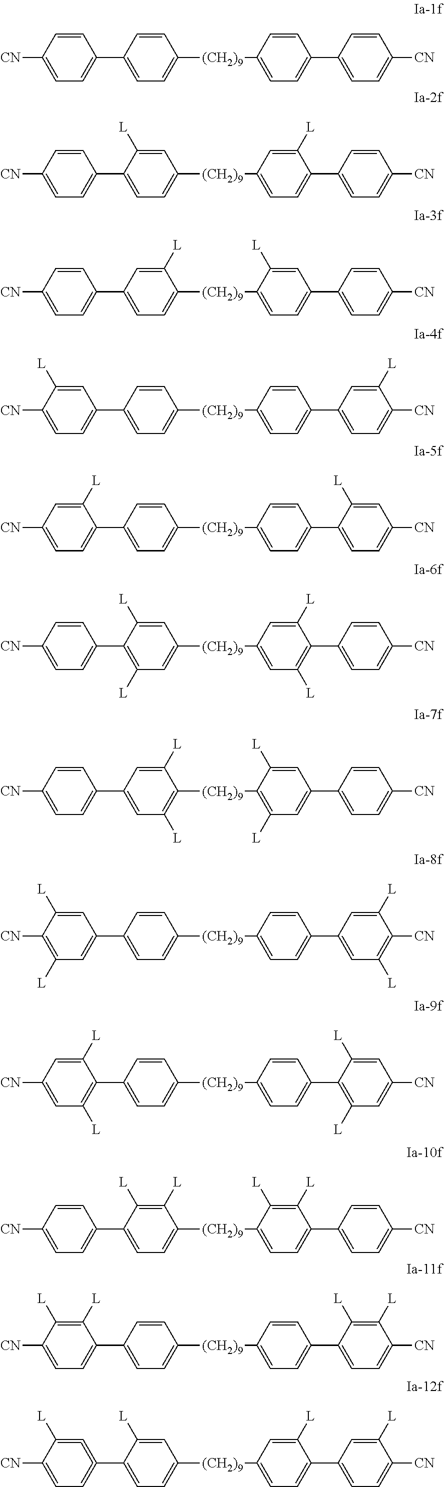

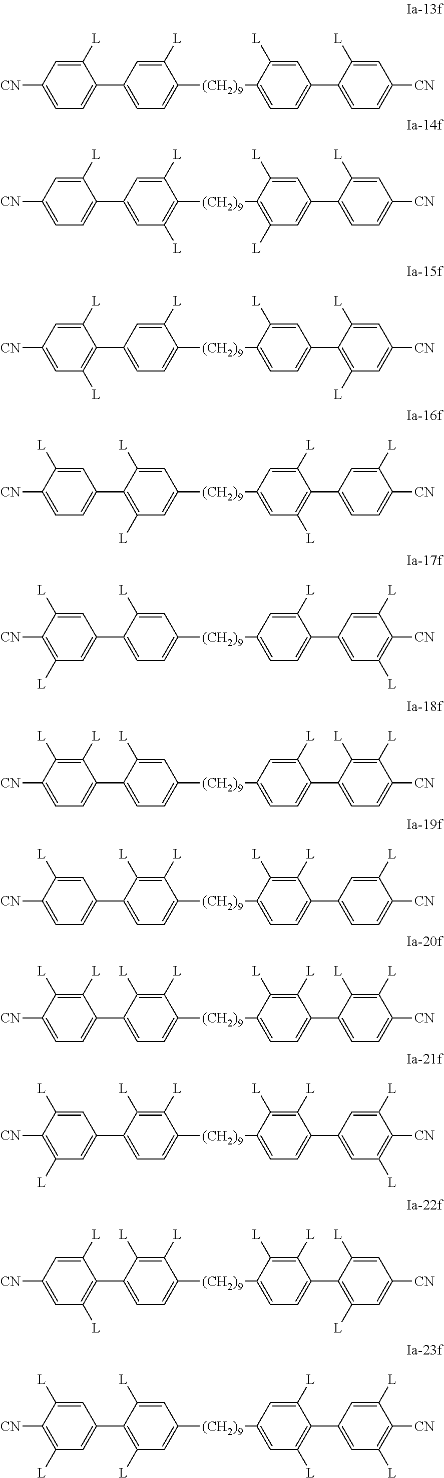

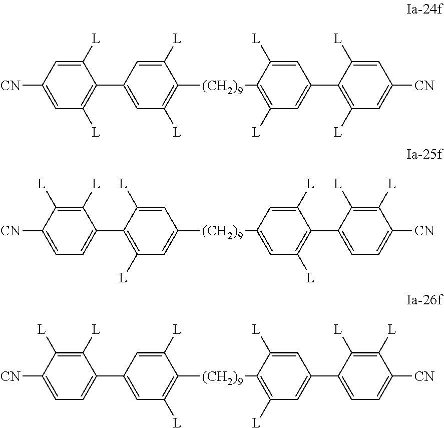

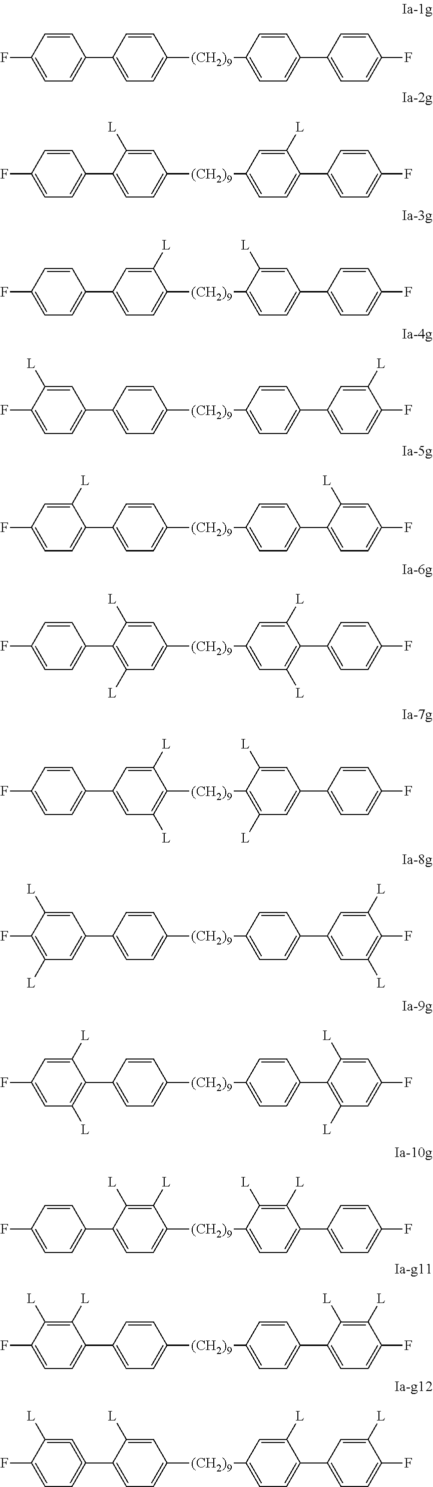

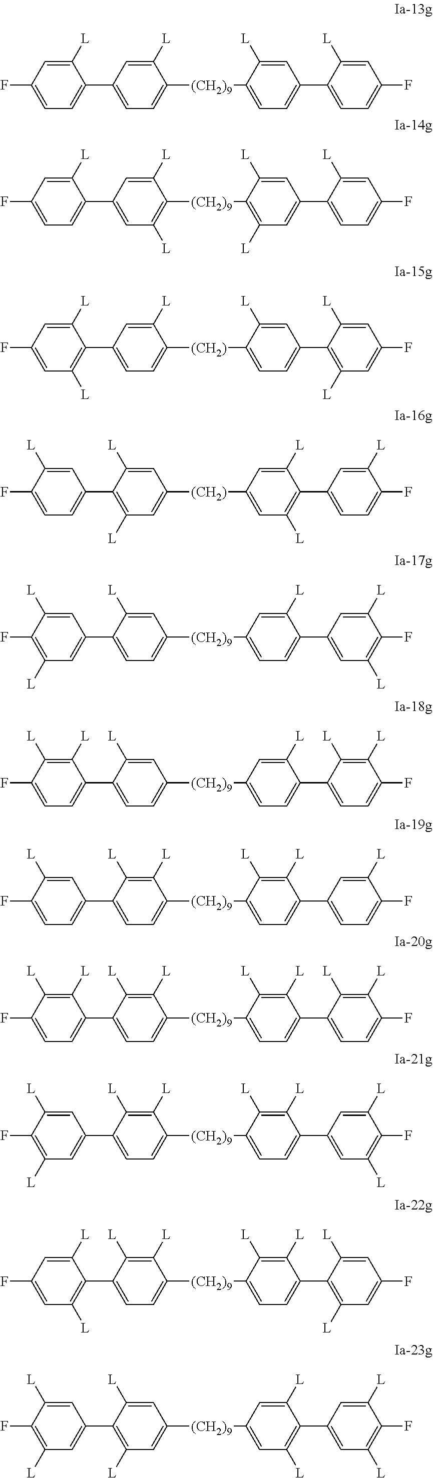

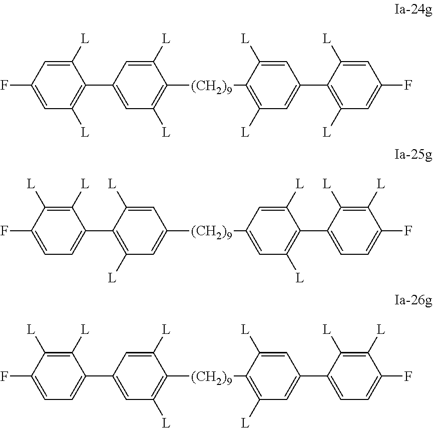

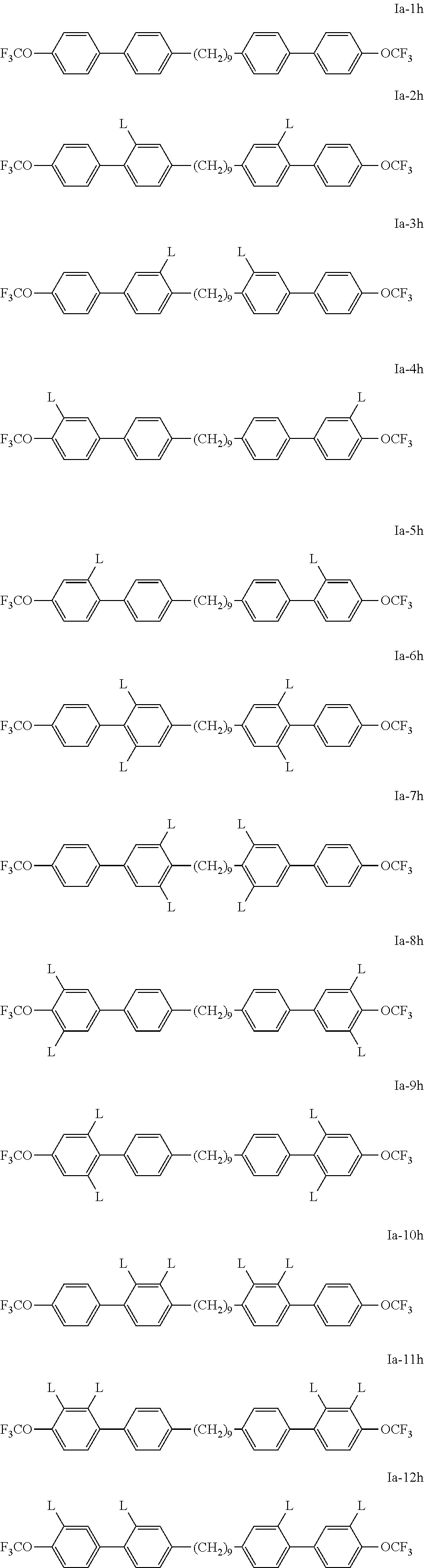

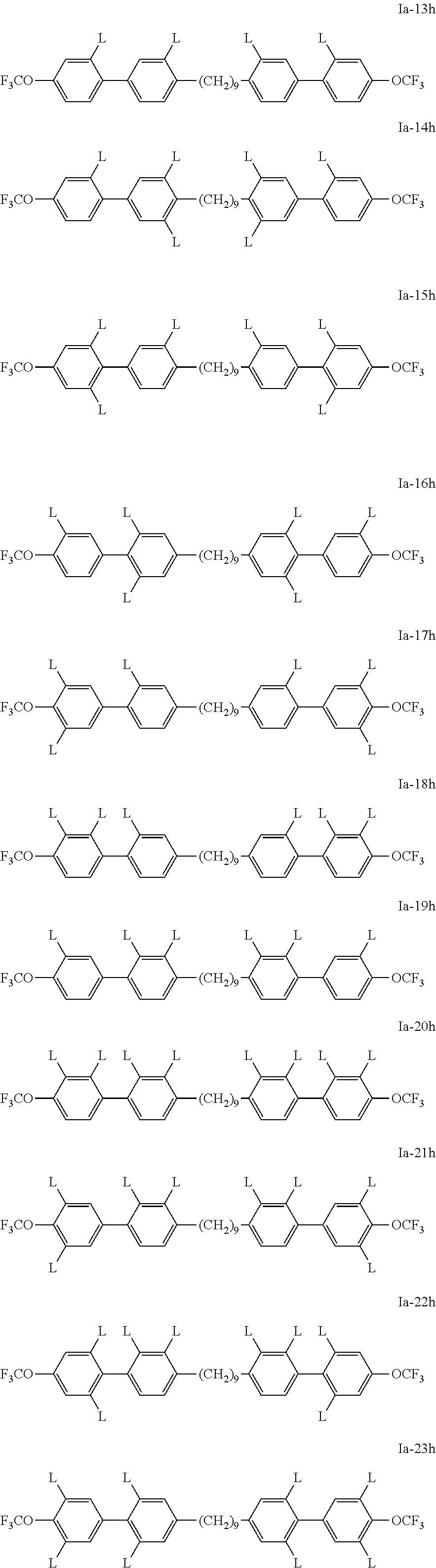

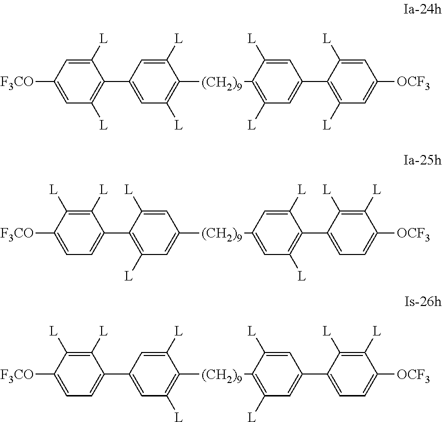

wherein L is in each occurrence independently of each other preferably F, Cl, CN, OH, NO2 or an optionally fluorinated alkyl, alkoxy or alkanoyl group with 1 to 7 C atoms, very preferably F, Cl, CN, OH, NO2, CH3, C2H5, OCH3, OC2H5, COCH3, COC2H5, COOCH3, COOC2H5, CF3, OCF3, OCHF2, OC2F5, in particular F, Cl, CN, CH3, C2H5, OCH3, COCH3 and OCF3, most preferably F, Cl, CH3, OCH3 and COCH3.

In particular preferred are the compounds of the formulae Ia-1a, Ia-2a, Ia-2b, Ia-17c, Ia-8e, Ia-3f, Ia-5f, Ia-6f, Ia-12f, Ia-23f, wherein L is in each occurrence independently of each other preferably F, Cl, CH₃, OCH₃ and COCH₃.

Most preferred compounds of the formulae I are indicated below:

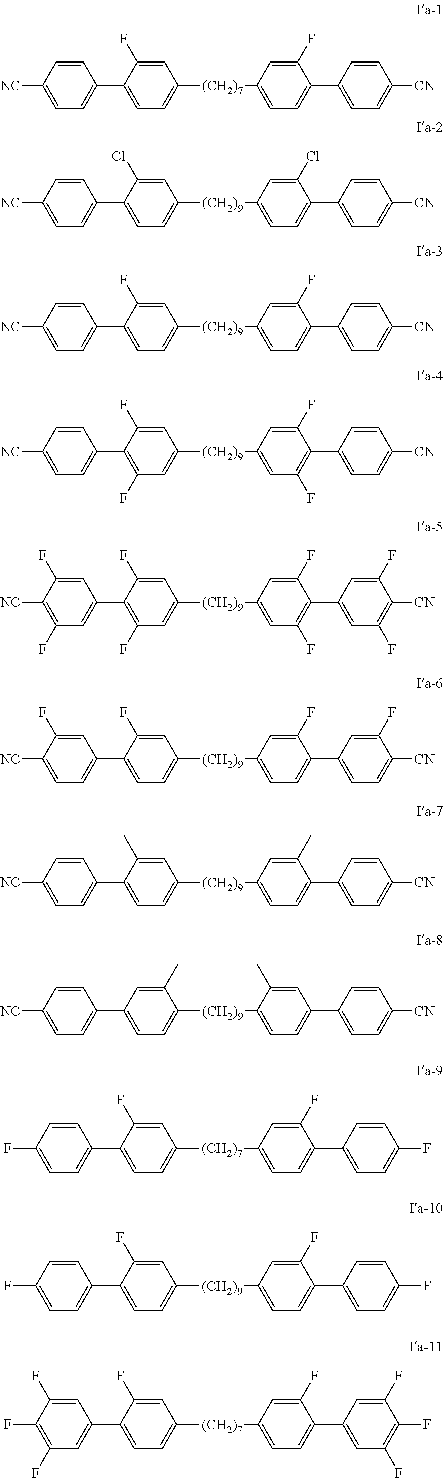

The compounds of formula I can be synthesized according to or in analogy to methods which are known per se and which are described in standard works of organic chemistry such as, for example, Houben-Weyl, Methoden der organischen Chemie, Thieme-Verlag, Stuttgart. A preferred method of preparation can be taken from WO 2013/004333 A1.

As commonly known, for example, from WO 2013/004333 A1 or WO 2013/174481 A1, the alkyl linked bimesogenic compounds of formula I are capable to induce N_{TB} phases. However, one drawback of this type of compounds is that they often crystallize very easily while utilized in higher concentrations.

Preferred compounds of formula II are selected from compounds in which u denotes 0 and the group (-A²¹-A²²-) is selected from the groups MG-1 to MG-8 as given above.

Further preferred compounds of formula II are selected from compounds in which u denotes 1 and the groups (-A²⁴-A²⁵-A²⁶-) and (-A²¹-A²²-A²³-) are each and independently selected from the following groups

| | |
|---|---|
| -Cyc-Cyc-Cyc- | MG-9 |
| -Phe-Phe-Cyc- | MG-10 |
| -Phe-Cyc-Phe- | MG-11 |
| -Cyc-Phe-Cyc- | MG-12 |
| -Phe-Cyc-Cyc- | MG-13 |
| -Phe-Phe-Phe- | MG-14 |
| -Phe-Phe-PheL- | MG-15 |
| -Phe-PheL-Phe- | MG-16 |
| -PheL-Phe-Phe- | MG-17 |
| -PheL-Phe-PheL- | MG-18 |
| -PheL-PheL-Phe- | MG-19 |
| -PheL-PheL-PheL- | MG-20 |
| -Phe-PheL-Cyc- | MG-21 |
| -Phe-Cyc-PheL- | MG-22 |
| -Cyc-Phe-PheL- | MG-23 |
| -PheL-Cyc-PheL- | MG-24 |
| -PheL-PheL-Cyc- | MG-25 |
| -PheL-Cyc-Cyc- | MG-26 |
| -Cyc-PheL-Cyc- | MG-27 |

wherein
Cyc, Phe, PheL an L have one of the meanings given above for the groups MG-1 to MG-8.

Further preferred compounds of formula II are selected from compounds in which u denotes 0 and the group (-A²¹-A²²-) is selected from the groups MG-1 to MG-8 as given above, and in which the group (-A²⁴-A²⁵-A²⁶-) is selected from the groups MG-9 to MG-27.

Especially preferred compounds of formula II are selected from the group of compounds of the following formulae,

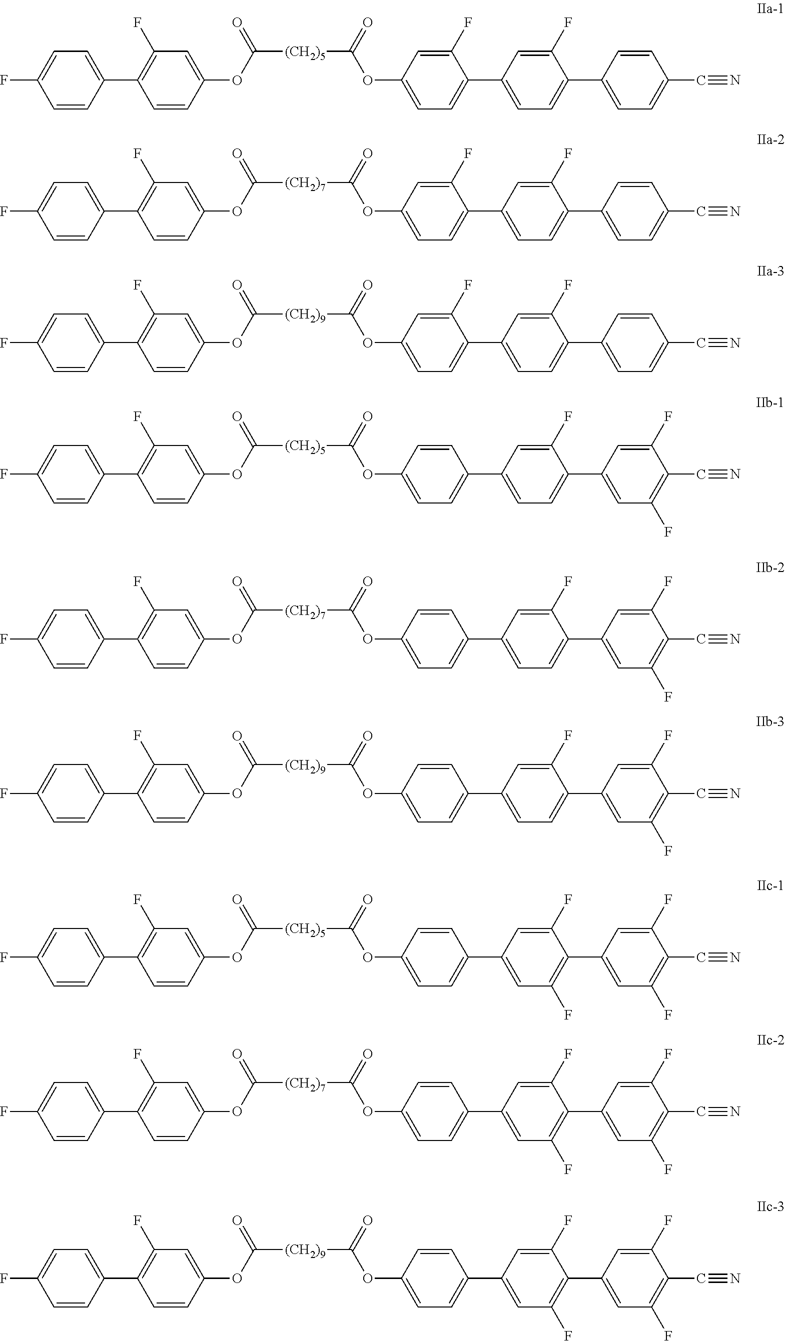

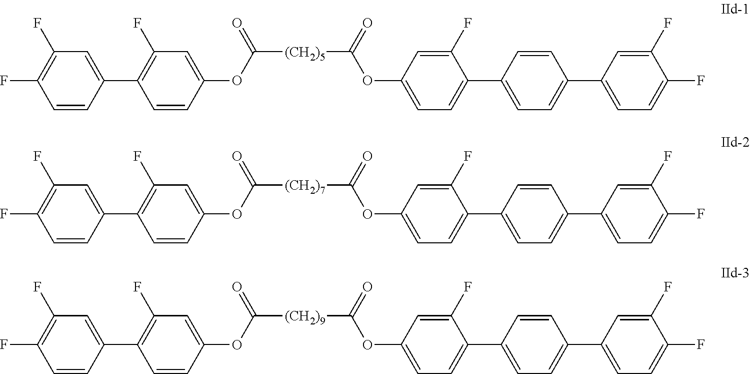

The compounds of formula II can be synthesized according to or in analogy to methods which are known per se and which are described in standard works of organic chemistry such as, for example, Houben-Weyl, Methoden der organischen Chemie, Thieme-Verlag, Stuttgart.

The unique properties of the media in accordance with the present invention as described above and below, are achieved by using especially a combination of compounds of formula I and II. Both compounds are characterized by high stabilities, suitable clearing points.

This media according to the present invention use a particular ratio of compounds of formula I and of compounds of formula II in order to give resultant media that is both stable against crystallization and exhibiting a room temperature N_{T} phase. In particular, the media of the present invention utilizes a ratio of compounds of formulae I and II in the range from 3:1, preferably 2:1, more preferably 1.5:1, and in particular 1.25:1, especially 1:1, or even 0.75:1.

In further preferred embodiment, the LC medium in accordance with the present invention additionally comprises one, two, three or more compounds of formula III,

R³¹-A³¹-A³²-Z³¹—(CH₂)_{z}—Z³²-A³³-A³⁴-R³² III

wherein
R³¹ and R³² have each and independently one of the meanings as given above for R¹¹ under formula I,
A³¹ to A³⁴ have each and independently one of the meanings as given above for A¹¹ under formula I,
Z³¹ and Z³² are each independently in each occurrence, —COO—, —OCO—, —O—CO—O—, —OCH₂—, —CH₂O—, —OCF₂—, —CF₂O—, —CH₂CH₂—, —(CH₂)₄—, —CF₂CF₂—, —CH═CH—, —CF═CF—, —CH═CH—COO—, —OCO—CH═CH— or —C≡C—, optionally substituted with one or more of F, S and/or Si, preferably —COO—, —OCO—, or —O—CO—O—, more preferably —COO—, or —OCO—.
z denotes an integer from 1 to 15, preferably an odd (i.e. uneven) integer and, more preferably 3, 5, 7 or 9.

Preferred compounds of formula III are selected from compounds in which the groups (-A³¹-A³²-) and (-A³³-A³⁴-) are each and independently selected from the groups of MG-1 to MG-8 as given above.

Especially preferred compounds of formula III are selected from the group of compounds of the following formulae:
symmetrical ones (IIIa and IIIb):

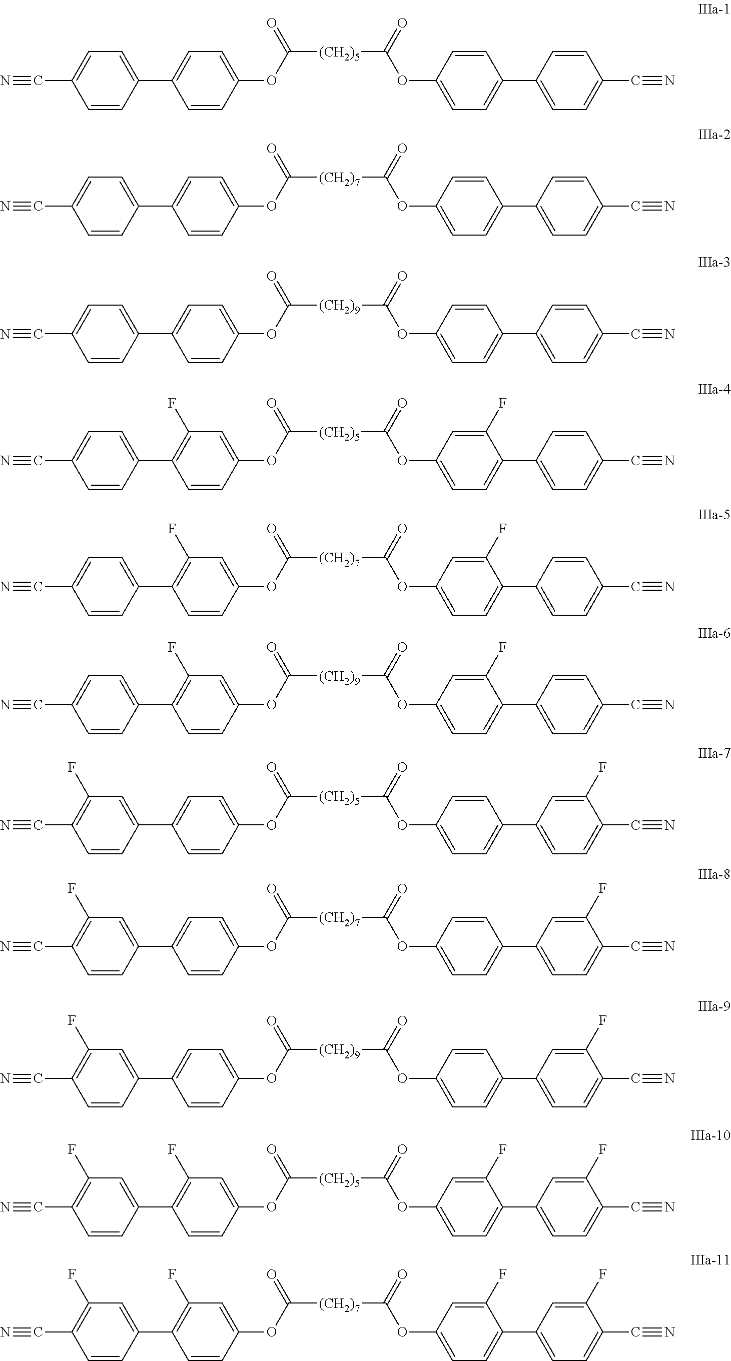

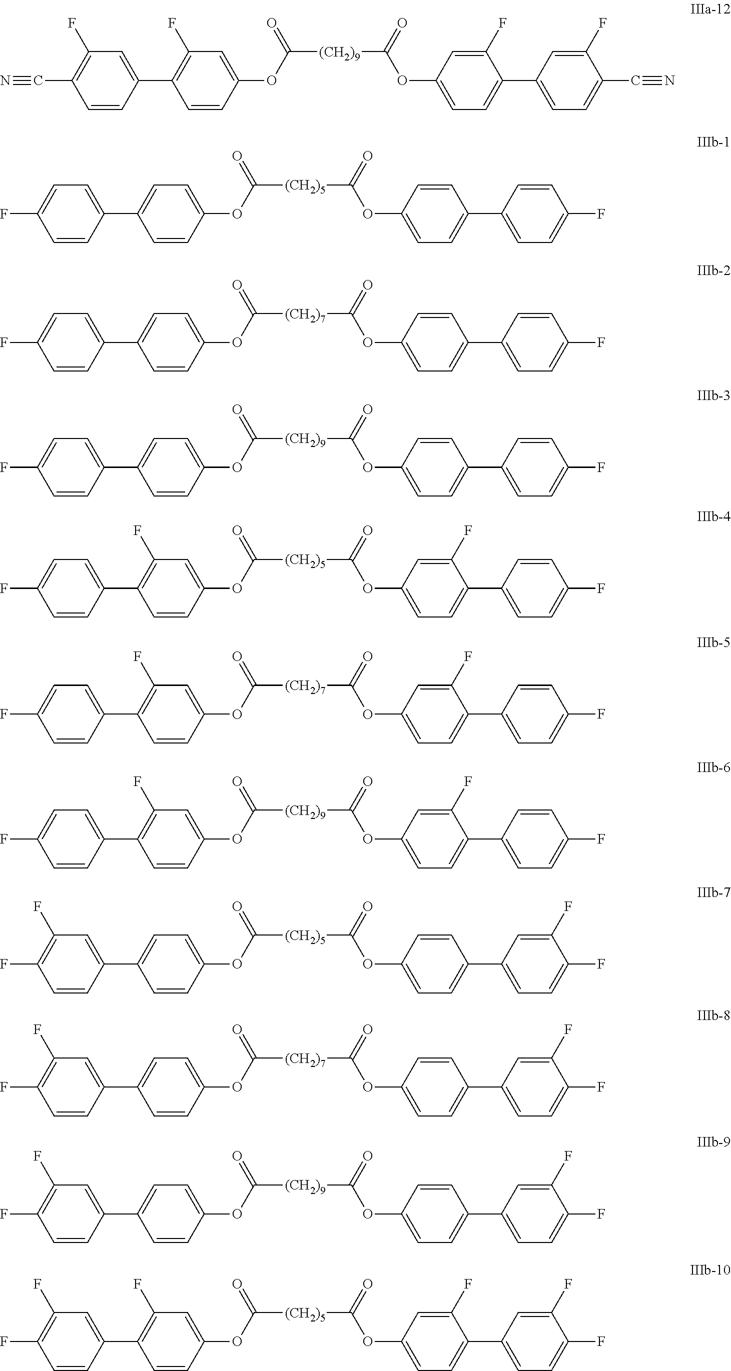

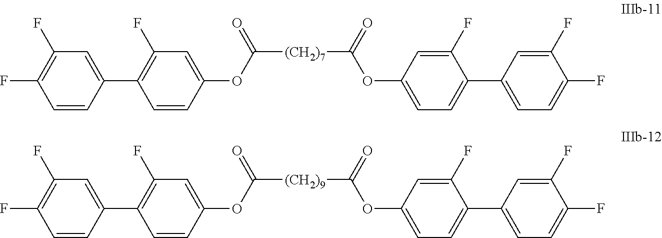

non-symmetrical ones IIIc:

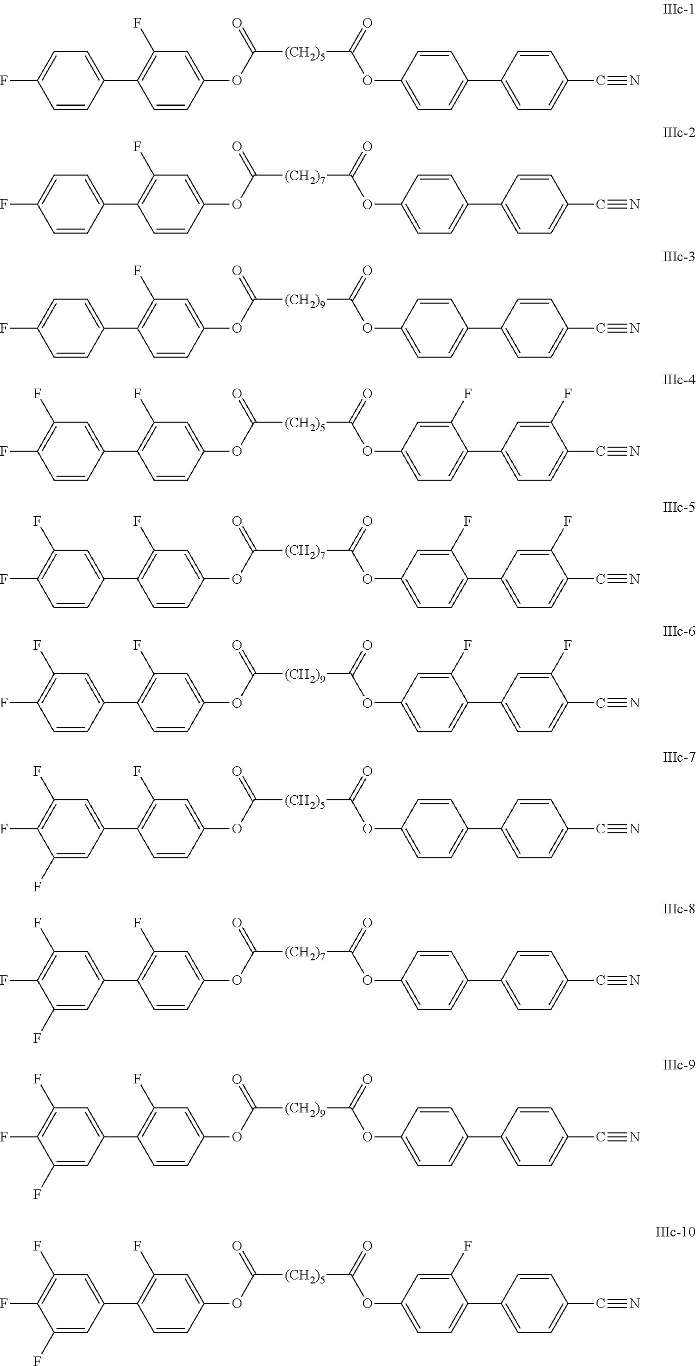

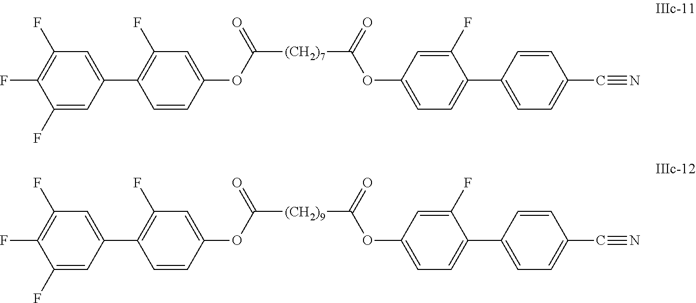

The compounds of formula III can be synthesized according to or in analogy to methods which are known per se and which are described in standard works of organic chemistry such as, for example, Houben-Weyl, Methoden der organischen Chemie, Thieme-Verlag, Stuttgart.

In a further preferred embodiment, the LC medium in accordance with the present invention additionally comprises one or more compounds of formula IV,

R⁴¹-A⁴¹-A⁴²-Z⁴¹—(CH₂)_{w}-A⁴³-A⁴⁴-R⁴² IV

wherein
R⁴¹ and R⁴² have each and independently one of the meanings as given above for R¹¹ under formula I,
A³¹ to A³⁴ have each and independently one of the meanings as given above for A¹¹ under formula I,
Z⁴¹ denotes —O—, —COO—, —OCO—, —O—CO—O—, —OCH₂—, —CH₂O, —CH₂CH₂—, —(CH₂)₄—, —CF₂CF₂—, —CH═CH—, —CF═CF—, —CH═CH—COO—, —OCO—CH═CH— or —C≡C—, optionally substituted with one or more of F, S and/or Si, preferably —O—, —COO—, —OCO—, or —O—CO—O—, more preferably —O—, —COO—, or —OCO—, and
w denotes an integer from 1 to 15, preferably an odd (i.e. uneven) integer and, more preferably 3, 5, 7 or 9.

Preferred compounds of formula IV are selected from compounds in which the groups (-A⁴¹-A⁴²-) and (-A⁴³-A⁴⁴-) are each and independently selected from the groups of MG-1 to MG-8 as given above.

Further preferred are compounds of formula IV wherein the groups (-A⁴¹-A⁴²-) and (-A⁴³-A⁴⁴-) in formula IV are not identical or not mirror images.

Especially preferred compounds of formula IV are selected from the group of compounds of the following formulae,

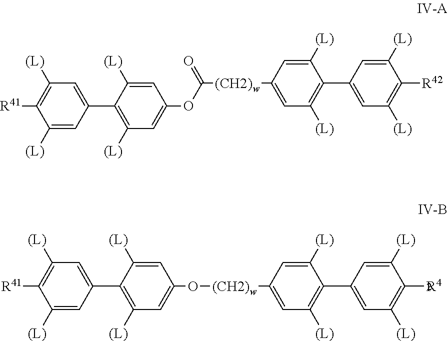

wherein R⁴¹ and R⁴² are independently from each other as defined above, including the preferred meanings of these groups, preferably R⁴¹ is F or CN, preferably R⁴² is OCF₃, CF₃, F or CN, more preferably F or CN and most preferably CN and wherein L is in each occurrence independently of each other F, Cl or preferably F or Cl, most preferably F, and w denotes preferably 5, 7, or 9.

Further preferred are compounds of formula IV wherein the groups (-A⁴¹-A⁴²-) and (-A⁴³-A⁴⁴-) in formula IV are not identical or not mirror images.

In particular preferred compounds of formula IV are selected from the group of compounds of the following formulae,

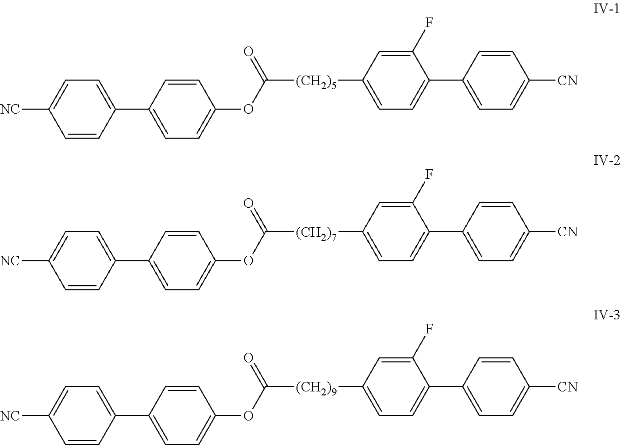

The compounds of formula IV can be synthesized according to or in analogy to methods which are known per se and which are described in standard works of organic chemistry such as, for example, Houben-Weyl, Methoden der organischen Chemie, Thieme-Verlag, Stuttgart. Preferably, the compounds of formula IV are synthesized according to or in analogy to methods which are disclosed for example in WO 2014/005672 A1.

In a further preferred embodiment, the LC medium in accordance with the present invention additionally comprises one, two, three or more compounds of formula V,

R⁵¹-A⁵¹-Z⁵¹-A⁵²-(Z⁵²-A⁵³)ₗ-(CH₂)ₚ-(A⁵⁴-Z⁵³-)ₘA⁵⁵-Z⁵⁴-A⁵⁶-R⁵² V

wherein
R⁵¹ and R⁵² have each and independently one of the meanings as given above for R¹¹ under formula I,
A⁵¹ to A⁵⁶ have each and independently one of the meanings as given above for A¹¹ under formula I,
Z^{s5} to Z⁵⁴ each and independently denotes —COO—, —OCO—, —O—CO—O—, —OCH₂—, —CH₂O—, —CH₂CH₂—, —(CH₂)₄—, —OCF₂—, —CF₂O—, —CF₂CF₂—, —CH═CH—, —CF═CF—, —CH═CH—COO—, —OCO—CH═CH— or —C≡C—, optionally substituted with one or more of F, S and/or Si, or a single bond, preferably —COO—, —OCO—, —O—CO—O—, or a single bond more preferably —COO—, or —OCO—, or a single bond with the proviso that at least one of Z⁵¹ to Z54 is not a single bond,
p denotes an integer from 1 to 15, preferably an odd (i.e. uneven) integer and, more preferably 3, 5, 7 or 9, and
l and m each and independently denotes 0 or 1, preferably both 0.

Preferred compounds of formula IV are selected from compounds in which at least one of the groups (-A⁵¹-Z⁵¹-A⁵²-(Z⁵²-A⁵³)ₗ-, -(A⁵⁴-Z⁵³-)ₘA⁵⁵-Z⁵⁴-A⁵⁶-) are is selected from the groups of MGa to MGn (the two reference Nos. “MG i” and “MG l” being deliberately omitted to avoid any confusion) and their mirror images

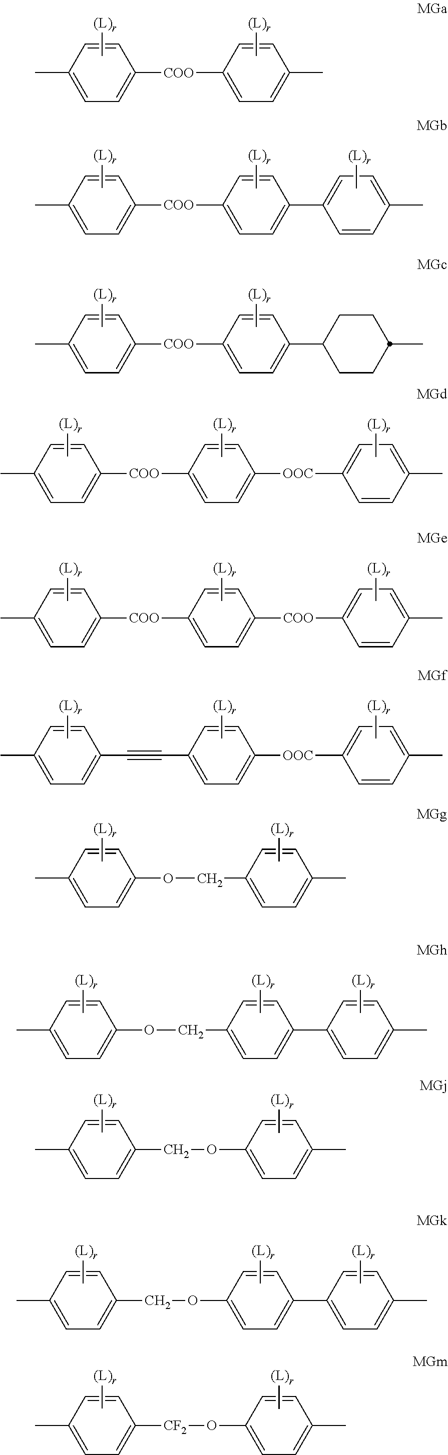

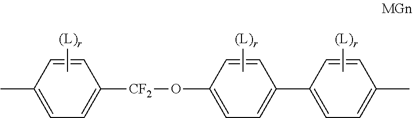

wherein
wherein L is in each occurrence independently of each other preferably F, Cl, CN, or an optionally fluorinated alkyl, alkoxy or alkanoyl group with 1 to 7 C atoms, very preferably F, Cl, CN, CH₃, C₂H₅, OCH₃, OC₂H₅, COCH₃, COC₂H₅, COOCH₃, COOC₂H₅, CF₃, OCF₃, OCHF₂, OC₂F₅, in particular F, Cl, CN, CH₃, C₂H₅, OCH₃, COCH₃ and OCF₃, most preferably F, Cl, CH₃, OCH₃ and COCH₃ and r is in each occurrence independently of each other 0, 1, 2, 3 or 4, preferably 0, 1 or 2.

The group

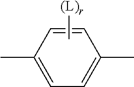

in these preferred formulae is very preferably denoting

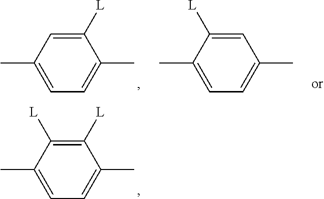

furthermore

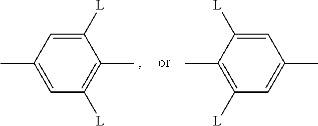

wherein L is preferably F, Cl, CH₃, OCH₃ and COCH₃.

Preferred compounds of formula V are selected from the group of compounds of formulae VA to VD

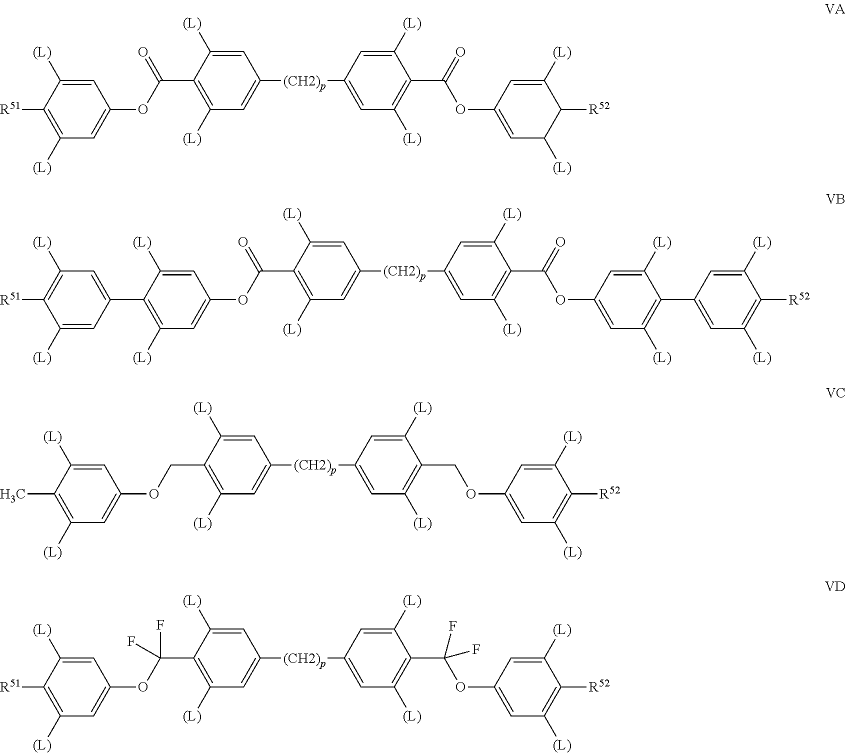

wherein R⁵¹ and R⁵² are independently from each other as defined above, including the preferred meanings of these groups, L is in each occurrence independently of each other F, Cl or preferably F or Cl, most preferably F, and p denotes 5, 7, or 9.

Further preferred are compounds of formula V wherein the groups (-A⁵¹-Z⁵¹-A⁵²-(Z⁵²-A⁵³)ₗ- and -(A⁵⁴-Z⁵³-)ₘA⁵⁵-Z⁵⁴-A⁵⁶-) in formula V are identical or mirror images with the proviso that at least one of Z⁵¹ to Z⁵⁴ is not a single bond.

Further preferred are compounds of formula V, wherein l and m denotes 0 or 1, more preferably l an m both denote 0.

Especially preferred compounds of formula V are selected from the group of compounds of the following formulae,

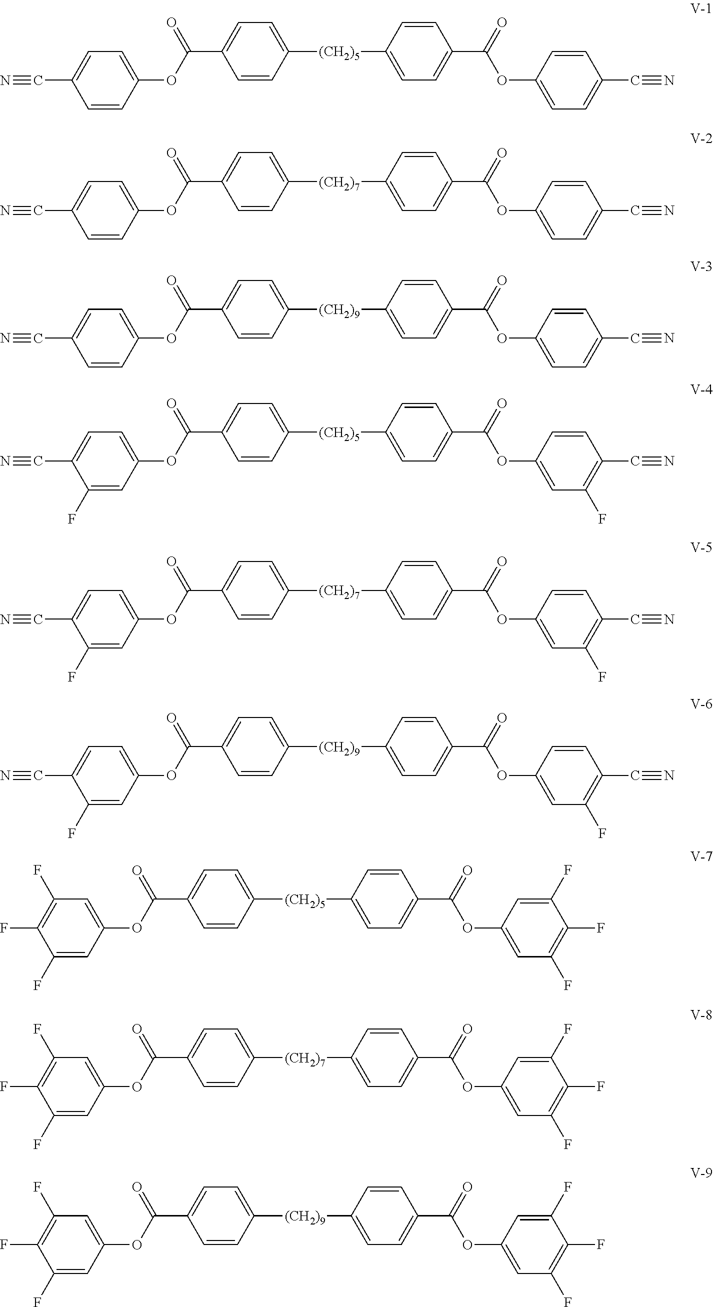

The compounds of formula V can be synthesized according to or in analogy to methods which are known per se and which are described in standard works of organic chemistry such as, for example, Houben-Weyl, Methoden der organischen Chemie, Thieme-Verlag, Stuttgart. Preferably, the compounds of formula V are synthesized according to or in analogy to methods which are disclosed for example in WO 2013/174478 A1.

In a further preferred embodiment, the medium in accordance with the present invention optionally comprises one or more chiral dopants, especially when utilized in a flexoelectric device.

The chiral compounds induce a chiral nematic texture with a pitch (P0), which is in a first approximation inversely proportional to the concentration (c) of the chiral material used. The constant of proportionality of this relation is called the helical twisting power (HTP) of the chiral substance and defined by the following equation

HTP≡1/(c·P0) (1)

wherein
c is concentration of the chiral compound.

For example, a uniform lying helix texture is realized using a chiral nematic liquid crystal with a short pitch, typically in the range from 0.2 μm to 1 μm, preferably of 1.0 μm or less, in particular of 0.5 μm or less, which is unidirectional aligned with its helical axis parallel to the substrates, e.g. glass plates, of a liquid crystal cell. In this configuration the helical axis of the chiral nematic liquid crystal is equivalent to the optical axis of a birefringent plate.

Preferred are chiral dopants with a high helical twisting power (HTP), in particular those disclosed in WO 98/00428.

Typically used chiral dopants are e.g. the commercially available R/S-5011, CD-1, R/S—811 and CB-15 (from Merck KGaA, Darmstadt, Germany).

In another preferred embodiment, the chiral dopants are preferably selected from formula VI

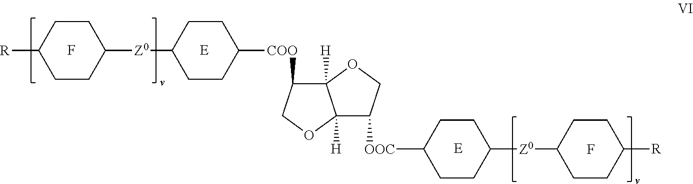

and/or formula VII

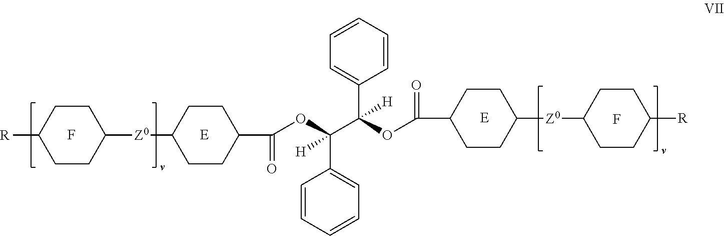

including the respective (S,S) enantiomer,
wherein E and F are each independently 1,4-phenylene or trans-1,4-cyclo-hexylene, v is 0 or 1, Z⁰ is —COO—, —OCO—, —CH₂CH₂— or a single bond, and R is alkyl, alkoxy or alkanoyl with 1 to 12 C atoms.

The compounds of formula VI and their synthesis are described in WO 98/00428. The compounds of formula VII and their synthesis are described in GB 2,328,207.

The above mentioned chiral dopants R/S-5011 and the compounds of formula VI and VII exhibit a very high helical twisting power (HTP), and are therefore particularly useful for the purpose of the present invention.

The liquid crystalline medium preferably comprises preferably 1 to 5, in particular 1 to 3, very preferably 1 or 2 chiral dopants, preferably selected from the above formula VI, and/or formula VII and/or R-5011 or S-5011, very preferably, the chiral compound is R-5011, S-5011.

The amount of chiral compounds in the liquid crystalline medium is preferably from 1 to 15%, in particular from 0.5 to 10%, very preferably 0.1 to 5% by weight of the total mixture.

Further preferred are liquid crystalline media optionally comprising one or more additives selected from the following formula VIII,

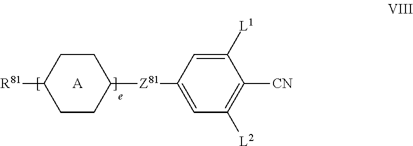

wherein
R⁸¹ is alkyl, alkoxy, alkenyl or alkenyloxy with up to 12 C atoms,

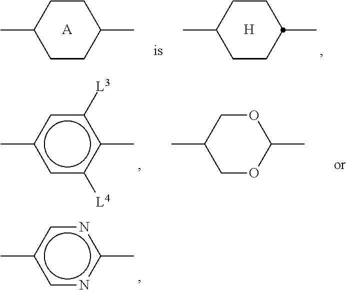

L¹ to L⁴ are each independently H or F,
Z⁸¹ is —COO—, —CH₂CH₂— or a single bond,
e is 1 or 2

Particularly preferred compounds of formula VIII are selected from the following formulae

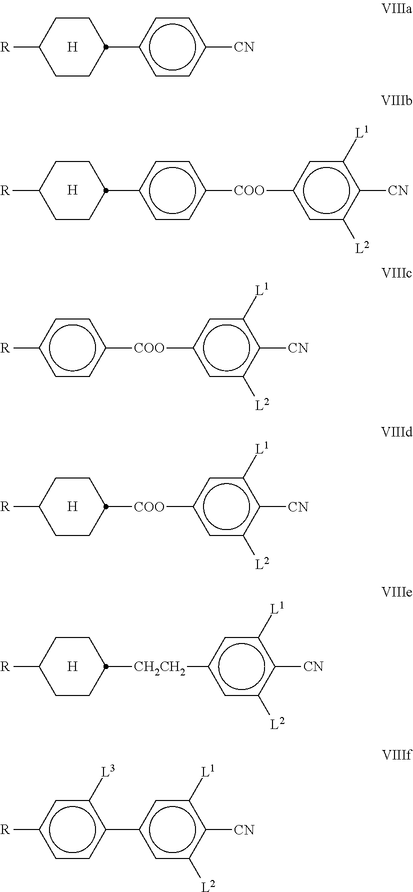

wherein, R has one of the meanings of R⁸¹ above and L¹, L² and L³ have the above meanings.

The liquid crystalline medium preferably comprises preferably 1 to 5, in particular 1 to 3, very preferably 1 or 2, preferably selected from the above formulae Villa to VIIIf, very preferably from formulae VIIIf.

The amount of suitable additives of formula VIII in the liquid crystalline medium is preferably from 1 to 20%, in particular from 1 to 15%, very preferably 1 to 10% by weight of the total mixture.

The liquid crystal media may contain further additives like for example stabilizers, inhibitors, surface-active compounds, lubricating agents, wetting agents, dispersing agents, hydrophobing agents, adhesive agents, flow improvers, defoaming agents, deaerators, diluents, reactive diluents, auxiliaries, colourants, dyes, pigments or nanoparticles in usual concentrations. The total concentration of these further constituents is in the range of 0.1% to 10%, preferably 0.1% to 6%, based on the total mixture. The concentrations of the individual compounds used each are preferably in the range of 0.1% to 3%.

The concentration of these and of similar additives is not taken into consideration for the values and ranges of the concentrations of the liquid crystal components and compounds of the liquid crystal media in this application. This also holds for the concentration of the dichroic dyes used in the mixtures, which are not counted when the concentrations of the compounds respectively the components of the host medium are specified. The concentration of the respective additives is always given relative to the final doped mixture.

In general, the total concentration of all compounds in the media according to this application is 100%.

The liquid crystal media according to the present invention consists of several compounds, preferably of 2 to 30, more preferably of 3 to 20 and most preferably of 4 to 16 compounds.

The media in accordance with the present invention exhibit high values of the elastic constant k₁₁ and a high flexoelectric coefficient e. The liquid crystal media preferably exhibit a k₁₁<100 pN, preferably <20 pN. The liquid crystal media preferably exhibit a k₃₃<100 pN, preferably <15 pN. The liquid crystal media preferably exhibit a flexoelectric coefficient |e₁₁|>0.2 pC/m, preferably >1 pC/m. The liquid crystal media preferably exhibit a flexoelectric coefficient |e₃₃>0.2 pC/m, preferably >2 pC/m.

The media in accordance with the present invention exhibit high clearing points up to 60° C. and higher, preferably up 65° C. and higher, and more preferably up to 70° C. and higher.

The media in accordance with the present invention exhibit broad nematic phases of 30° C. and more, preferably 35° C. and more, or even 40° C. or more.

The media in accordance with the present invention exhibit broad N_{T}e phases of 30° C. and more, preferably 35° C. and more, and more preferably of 40° C. or more, which exist at temperatures between +40° C. to −20° C., preferably between +35° C. to −20° C., more preferably between 28° C. to −17° C.

The media in accordance with the present invention exhibit broad N_{TB} phases of 30° C. and more, preferably 35° C. and more, and more preferably of 40° C. or more.

The media in accordance with the present invention exhibit high stabilities against crystallization at room temperature of more than 100 h, preferably more than 250 h or more than 1000 h.

The media in accordance with the present invention exhibit high stabilities against crystallization even at low temperatures (LTS). Accordingly the media do not crystallize even at temperatures down to 0° C., preferably down to −10° C., more preferably down to −20° C.

In a preferred embodiment the LC medium comprises:
1 to 5, in particular 1 to 3, very preferably 1 or 2 compounds of formula I, preferably selected from formulae Ia-1a, Ia-2a, Ia-2b, Ia-17c, Ia-8e, Ia-3f, Ia-5f, Ia-6f, Ia-12f, and/or Ia-23f, in particular at least one compound selected from compounds of formulae I′a-1 to I′a-11. The amount of compounds of formula I in the liquid crystalline medium as a whole is preferably up to 27% or less, in particular up to 25% or less, especially up to 20% or less by weight of the total mixture,
and
1 to 5, in particular 1 to 3, very preferably 1 compounds of formula II, preferably selected from compounds of the above formulae IIa to IId, very preferably at least one compound of formula IIc, in particular the compound of formula IIc-3. The amount of compounds of formula II in the liquid crystalline medium as a whole is preferably at least 10% or more, more preferably at least 15% or more, even more preferably at least 20% or more, and most preferably at least 25% or more by weight of the total mixture,
optionally, 1 to 7, in particular 1 to 5, very preferably 1 to 3 compounds of formula III, preferably selected from symmetrical compounds of the above formulae IIIa and/or IIIb and/or from non-symmetrical compounds of the above formulae IIIc, very preferably at least one compound of formula IIIb and/or at least one compound of formulae IIIc. The amount of compounds of formula III in the liquid crystalline medium as a whole is preferably from 10 to 70%, in particular from 20 to 60%, very preferably 30 to 50% by weight of the total mixture and preferably from 5 to 30%, more preferably 10 to 20% of the total mixture of an individual compound of formula III.
optionally, 1 to 5, in particular 1 to 3, very preferably 1 or 2 compounds of formula IV, preferably selected from the above formulae IV-A and IV-B, very preferably from formulae IV-1 to IV-3. The amount of compounds of formula IV in the liquid crystalline medium as a whole is preferably from 1 to 15%, in particular from 2 to 10%, very preferably 3 to 5% by weight of the total mixture and preferably from 1 to 5% of the total mixture of an individual compound of formula IV.
optionally, 1 to 5, in particular 1 to 3, very preferably 1 or 2 compounds of formula V, preferably selected from the above formulae V-1 to V-9, very preferably from formulae V-2 and/or V-5. The amount of compounds of formula V in the liquid crystalline medium as a whole is preferably from 1 to 20%, in particular from 3 to 15%, very preferably 5 to 10% by weight of the total mixture and preferably from 1 to 10%, more preferably from 2 to 5% of the total mixture of an individual compound of formula V.
optionally, 1 to 5, in particular 1 to 3, very preferably 1 or 2 chiral dopants, preferably selected from the above formula VI, and/or formula VII and/or R-5011 or S-5011, very preferably, the chiral compound is R-5011, or S-5011. The amount of chiral compounds in the liquid crystalline medium, if present, is preferably from 1 to 15%, in particular from 0.5 to 10%, very preferably 0.1 to 5% by weight of the total mixture.
optionally 1 to 5, in particular 1 to 3, very preferably 1 or 2, preferably selected from the above formulae Villa to VIIIf, very preferably from formulae VIIIf. The amount of suitable additives of formula VIII in the liquid crystalline medium, if present, is preferably from 1 to 20%, in particular from 1 to 15%, very preferably 1 to 10% by weight of the total mixture.
optionally further additives in usual concentrations. The total concentration of these further constituents, if present, is in the range of 0.1% to 10%, preferably 0.1% to 6%, based on the total mixture. The concentrations of the individual compounds used each are preferably in the range of 0.1% to 3%.

In another preferred embodiment, the LC medium of the present invention consists only compounds selected from formula I to III, preferably only compounds selected from formula I to IV, more preferably only compounds selected from formula I to V, and especially only compounds selected from formula I to IV and a chiral dopant.

The compounds forming the LC medium in accordance with the present invention are mixed in conventional way. As a rule, the required amount of the compound used in the smaller amount is dissolved in the compound used in the greater amount. In case the temperature is above the clearing point of the compound used in the higher concentration, it is particularly easy to observe completion of the process of dissolution. It is, however, also possible to prepare the media by other conventional ways, e.g. using so called pre-mixtures, which can be e.g. homologous or eutectic media of compounds or using so called multi-bottle-systems, the constituents of which are ready to use media themselves. Thus the invention also relates to a process for the production of an LC medium as described above and below.

In particular, the invention relates to a process for the production of an LC medium comprising the steps of mixing not more than 30% of one or more compounds of formula I,

R¹¹-A¹¹-A¹²-(CH₂)ₛ-A¹³-A¹⁴-R¹² I

with at least 10% of one or more compounds of formula II,

R²¹-A²¹-A²²-(A²³)ᵤ-Z²¹—(CH₂)ₜ—Z²²-A²⁴-A²⁵-A²⁶-R²² II

wherein R¹¹ to R²², A¹¹ to A²⁶, Z²¹, Z²², s, t, and u have one the meanings as given herein below, with at least one compound selected from compounds of formula III, and/or IV, and/or V.

The liquid crystalline media in accordance with the present invention can be used in liquid crystal devices, such as STN, TN, AMD-TN, temperature compensation, guest-host, phase change or surface stabilized or polymer stabilized cholesteric texture (SSCT, PSCT) displays, in active and passive optical elements like polarizers, compensators, reflectors, alignment layers, colour filters or holographic elements, in adhesives, synthetic resins with anisotropic mechanical properties, cosmetics, diagnostics, liquid crystal pigments, for decorative and security applications, in nonlinear optics, optical information storage or as chiral dopants.

The media in accordance with the present invention are particularly useful for flexoelectric liquid crystal display applications, such as, for example, devices of the ULH or USH mode.

Thus, another object of the present invention is a liquid crystal device, preferably a flexoelectric device, comprising a medium, which comprises not more than 30% of one or more compounds of formula I,

R¹¹-A¹¹-A¹²-(CH₂)ₛ-A¹³-A¹⁴-R¹² I

and at least 10% of one or more compounds of formula II,

R²¹-A²¹-A²²-(A²³)ᵤ-Z²¹—(CH₂)ₜ—Z²²-A²⁴-A²⁵-A²⁶-R²² II

wherein R¹¹ to R²², A¹¹ to A²⁶, Z²¹, Z²², s, t, and u have one the meanings as given herein above.

A flexoelectric display according to a preferred embodiment of the present invention comprises two plane parallel substrates, preferably glass plates covered with a transparent conductive layer such as indium tin oxide (ITO) on their inner surfaces, optionally alignment layers and a medium, comprising a medium, which comprises not more than 30% of one or more compounds of formula I,

R¹¹-A¹¹-A¹²-(CH₂)ₛ-A¹³-A¹⁴-R¹² II

and at least 10% of one or more compounds of formula II,

R²¹-A²¹-A²²-(A²³)ᵤ-Z²¹—(CH₂)ₜ—Z²²-A²⁴-A²⁵-A²⁶-R²² II

wherein R¹¹ to R²², A¹¹ to A²⁶, Z²¹, Z²², s, t, and u have one the meanings as given herein above and a chiral dopant as described above and below.

If an electrical field is applied to this configuration normal to the helical axis the optical axis is rotated in the plane of the cell, similar as the director of a ferroelectric liquid crystal rotate as in a surface stabilized ferroelectric liquid crystal display.

The field induces a splay bend structure in the director which is accommodated by a tilt in the optical axis. The angle of the rotation of the axis is in first approximation directly and linearly proportional to the strength of the electrical field. The optical effect is best seen when the liquid crystal cell is placed between crossed polarizers with the optical axis in the unpowered state at an angle of 22.5° to the absorption axis of one of the polarizers. This angle of 22.5° is also the ideal angle of rotation of the electric field, as thus, by the inversion the electrical field, the optical axis is rotated by 45° and by appropriate selection of the relative orientations of the preferred direction of the axis of the helix, the absorption axis of the polarizer and the direction of the electric field, the optical axis can be switched from parallel to one polarizer to the centre angle between both polarizers. The optimum contrast is then achieved when the total angle of the switching of the optical axis is 45°. In that case the arrangement can be used as a switchable quarter wave plate, provided the optical retardation, i.e. the product of the effective birefringence of the liquid crystal and the cell gap, is selected to be the quarter of the wave length. In this context the wavelength referred to is 550 nm, the wavelength for which the sensitivity of the human eye is highest, unless explicitly stated otherwise.

The angle of rotation of the optical axis (Φ) is given in good approximation by the formula:

tan Φ=ēP₀E/(2πK)

wherein
P₀ is the undisturbed pitch of the cholesteric liquid crystal,
ē is the average [ē=½(e₁₁+e₃₃)] of the splay flexoelectric coefficient (e₁₁) and the bend flexoelectric coefficient (e₃₃),
E is the electrical field strength and
K is the average [K=½ (k₁₁+k₃₃)] of the splay elastic constant (k₁₁) and the bend elastic constant (k₃₃)
   and wherein
ē/K is called the flexo-elastic ratio.

This angle of rotation is half the switching angle in a flexoelectric switching element.

The response time (τ) of this electro-optical effect is given in good approximation by the formula:

τ=[P₀/(2π)]²·γ/K

wherein
γ is the effective viscosity coefficient associated with the distortion of the helix.

The flexoelectric effect is characterized by fast response times typically ranging from 6 μs to 100 μs. It further features excellent grey scale capability.

There is a critical field (E_{c}) to unwind the helix, which can be obtained from equation

E_{c}=(π²/P₀)·[k₂₂/(ε₀·Δε)]^{1/2}

wherein
k₂₂ is the twist elastic constant,
ε₀ is the permittivity of vacuum and
Δε is the dielectric anisotropy of the liquid crystal.

The inventive media in accordance with the present invention can be aligned in their cholesteric phase into different states of orientation by methods that are known to the expert, such as surface treatment or electric fields. For example, they can be aligned into the planar (Grandjean) state, into the focal conic state or into the homeotropic state.

The term “planar alignment” or orientation of a liquid crystal or mesogenic material in a display cell or on a substrate means that the mesogenic groups in the liquid crystal or mesogenic material are oriented substantially parallel to the plane of the cell or substrate, respectively.

The term “homeotropic alignment” or orientation of a liquid crystal or mesogenic material in a display cell or on a substrate means that the mesogenic groups in the liquid crystal or mesogenic material are oriented substantially perpendicular to the plane of the cell or substrate, respectively.

The switching between different states of orientation according to a preferred embodiment of the present invention is exemplarily described below in detail.

According to this preferred embodiment, the sample is placed into a cell comprising two plane-parallel glass plates coated with electrode layers, e.g. ITO layers, and aligned in its cholesteric phase into a planar state wherein the axis of the cholesteric helix is oriented normal to the cell walls. This state is also known as Grandjean state, and the texture of the sample, which is observable e.g. in a polarization microscope, as Grandjean texture. Planar alignment can be achieved e.g. by surface treatment of the cell walls, for example by rubbing and/or coating with an alignment layer such as polyimide.

A Grandjean state with a high quality of alignment and only few defects can further be achieved by heating the sample to the isotropic phase, subsequently cooling to the chiral nematic phase at a temperature close to the chiral nematic-isotropic phase transition, and flow alignment by lightly pressing the cell.

In the planar state, the sample shows selective reflection of incident light, with the central wavelength of reflection depending on the helical pitch and the mean refractive index of the material.

When an electric field is applied to the electrodes, for example with a frequency from 10 Hz to 1 kHz, and an amplitude of up to 12 Vᵣₘₛ/μm, the sample is being switched into a homeotropic state where the helix is unwound and the molecules are oriented parallel to the field, i.e. normal to the plane of the electrodes. In the homeotropic state, the sample is transmissive when viewed in normal daylight, and appears black when being put between crossed polarizers.

Upon reduction or removal of the electric field in the homeotropic state, the sample adopts a focal conic texture, where the molecules exhibit a helically twisted structure with the helical axis being oriented perpendicular to the field, i.e. parallel to the plane of the electrodes. A focal conic state can also be achieved by applying only a weak electric field to a sample in its planar state. In the focal conic state the sample is scattering when viewed in normal daylight and appears bright between crossed polarizers.

A sample of a medium in accordance with the present invention in different states of orientation exhibits different transmission of light. Therefore, the respective state of orientation, as well as its quality of alignment, can be controlled by measuring the light transmission of the sample depending on the strength of the applied electric field. Thereby it is also possible to determine the electric field strength required to achieve specific states of orientation and transitions between these different states.

In a sample of a medium in accordance with the present invention, the above described focal conic state consists of many disordered birefringent small domains. By applying an electric field greater than the field for nucleation of the focal conic texture, preferably with additional shearing of the cell, a uniformly aligned texture is achieved where the helical axis is parallel to the plane of the electrodes in large, well-aligned areas. In accordance with the literature on state of the art chiral nematic materials, such as P. Rudquist et al., Liq. Cryst. 23 (4), 503 (1997), this texture is also called uniformly-lying helix (ULH) texture. This texture is required to characterize the flexoelectric properties of the inventive compound.

In a preferred embodiment of the present invention, the sequence of textures typically observed in a sample having a Δe>0 on a rubbed polyimide substrate upon increasing or decreasing electric field is given below:

Starting from the ULH texture, the inventive media can be subjected to flexoelectric switching by application of an electric field. This causes rotation of the optic axis of the material in the plane of the cell substrates, which leads to a change in transmission when placing the material between crossed polarizers. The flexoelectric switching of inventive materials is further described in detail in the introduction above and in the examples.

It is also possible to obtain the ULH texture, starting from the focal conic texture, by applying an electric field with a high frequency, of for example 10 kHz, to the sample whilst cooling slowly from the isotropic phase into the cholesteric phase and shearing the cell. The field frequency may differ for different compounds.

Apart from the use in flexoelectric devices, the media in accordance with the present invention are also suitable for other types of displays and other optical and electro optical applications, such as optical compensation or polarizing films, colour filters, reflective cholesterics, optical rotatory power and optical information storage.

Without further elaboration, it is believed that one skilled in the art can, using the preceding description, utilize the present invention to its fullest extent. The following examples are, therefore, to be construed as merely illustrative and not limitative of the remainder of the disclosure in any way whatsoever.

Unless the context clearly indicates otherwise, as used herein plural forms of the terms herein are to be construed as including the singular form and vice versa.

Throughout the description and claims of this specification, the words “comprise” and “contain” and variations of the words, for example “comprising” and “comprises”, mean “including but not limited to”, and are not intended to (and do not) exclude other components.

Throughout the present application it is to be understood that the angles of the bonds at a C atom being bound to three adjacent atoms, e.g. in a C═C or C═O double bond or e.g. in a benzene ring, are 120° and that the angles of the bonds at a C atom being bound to two adjacent atoms, e.g. in a C≡C or in a C≡N triple bond or in an allylic position C═C═C are 180°, unless these angles are otherwise restricted, e.g. like being part of small rings, like 3-, 5- or 5-atomic rings, notwithstanding that in some instances in some structural formulae these angles are not represented exactly.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

The parameter ranges indicated in this application all include the limit values including the maximum permissible errors as known by the expert. The different upper and lower limit values indicated for various ranges of properties in combination with one another give rise to additional preferred ranges.

The total concentration of all compounds in the media according to this application is 100%. All concentrations are given in % w/w, unless explicitly stated otherwise.

In the foregoing and in the following examples, unless otherwise indicated, all temperatures are set forth uncorrected in degrees Celsius and all parts and percentages are by weight.

It goes without saying to the person skilled in the art that the LC media may also comprise compounds in which, for example, H, N, O, Cl, F have been replaced by the corresponding isotopes.

The following abbreviations are used to illustrate the liquid crystalline phase behaviour of the compounds: K=crystalline; N=nematic; N_{T}=second nematic; S or Sm=smectic; Ch=cholesteric; I=isotropic; Tg=glass transition. The numbers between the symbols indicate the phase transition temperatures in ° C.

In the present application and especially in the following examples, the structures of the liquid crystal compounds are represented by abbreviations, which are also called “acronyms”. The transformation of the abbreviations into the corresponding structures is straight forward according to the following three tables A to C.

All groups CₙH₂ₙ₊₁, CₘH₂ₘ₊₁, and CₗH₂ₗ₊₁ are preferably straight chain alkyl groups with n, m and l C-atoms, respectively, all groups CₙH₂ₙ, CₘH₂ₘ and CₗH₂ₗ are preferably (CH₂)ₙ, (CH₂)ₘ and (CH₂)ₗ, respectively and —CH═CH— preferably is trans-respectively E vinylene.

Table A lists the symbols used for the ring elements, table B those for the linking groups and table C those for the symbols for the left hand and the right hand end groups of the molecules.

TABLE A
Ring Elements

| | |
|---|---|
| C | 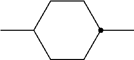 |
| P | 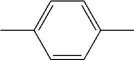 |
| D | 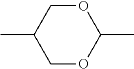 |
| DI | 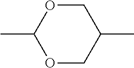 |
| A | 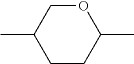 |
| AI | 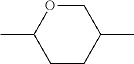 |
| G | 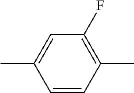 |
| GI | 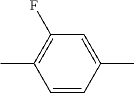 |
| G(CI) | 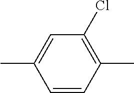 |
| GI(CI) | 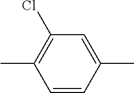 |
| G(1) | 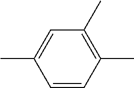 |
| GI(1) | 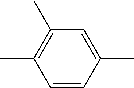 |
| U | 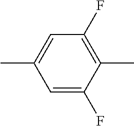 |
| UI | 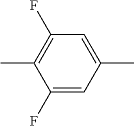 |
| Y | 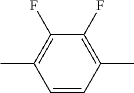 |
| M | 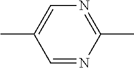 |
| MI | 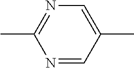 |
| N | 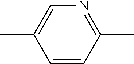 |
| NI | 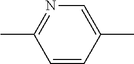 |
| np | 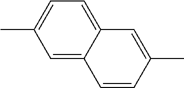 |
| th | 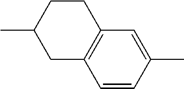 |
| thI | 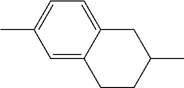 |
| dh | 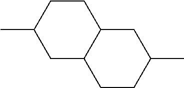 |
| L | 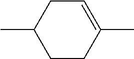 |
| LI | 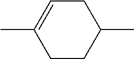 |
| F | 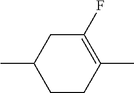 |
| FI | 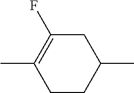 |

TABLE B
Linking Groups

| n | (—CH₂—)ₙ | “n” is an integer except 0 and 2 | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| 1O | —CH₂—O— | O1 | —O—CH₂— |
| Q | —CF₂—O— | QI | —O—CF₂— |

TABLE C
End Groups

| Left hand side, | | Right hand side, | |
|---|---|---|---|
| used alone or in combination with others | | used alone or in combination with others | |
| -n- | CₙH₂ₙ₊₁— | -n | —CₙH₂ₙ₊₁ |
| -nO- | CₙH₂ₙ₊₁-O— | -nO | —O—CₙH₂ₙ₊₁ |
| -V- | CH₂═CH— | -V | —CH═CH₂ |
| -nV- | CₙH₂ₙ₊₁—CH═CH— | -nV | —CₙH₂ₙ—CH═CH₂ |
| -Vn- | CH₂═CH—CₙH₂ₙ₋ | -Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| -N- | N≡C— | -N | —C≡N |
| -S- | S═C═N— | -S | —N═C═S |
| -F- | F— | -F | —F |
| -CL- | Cl— | -CL | —Cl |
| -M- | CFH₂— | -M | —CFH₂ |
| -D- | CF₂H— | -D | —CF₂H |
| -T- | CF₃— | -T | —CF₃ |
| -MO- | CFH₂O— | -OM | —OCFH₂ |
| -DO- | CF₂HO— | -OD | —OCF₂H |
| -TO- | CF₃O— | -OT | —OCF₃ |
| -A- | H—C≡C— | -A | —C≡C—H |
| -nA- | CₙH₂ₙ₊₁—C≡C— | -An | —C≡C—CₙH₂ₙ₊₁ |
| -NA- | N≡C—C≡C— | -AN | —C≡C—C≡N |
| Left hand side, used in | | Right hand side, used in | |
| combination with others only | | combination with others only | |
| -...n...- | (—CH₂—)ₙ | -...n... | (—CH₂—)ₙ |
| -...M...- | —CFH— | -...M... | —CFH— |
| -...D...- | —CF₂— | -...D... | —CF₂— |
| -...V...- | —CH═CH— | -...V... | —CH═CH— |
| -...Z...- | —CO—O— | -...Z... | —CO—O— |
| -...ZI...- | —O—CO— | -...ZI... | —O—CO— |
| -...K...- | —CO— | -...K... | —CO— |
| -...W...- | —CF═CF— | -...W... | —CF═CF— |

wherein n und m each are integers and three points “ . . . ” indicate a space for other symbols of this table.

### EXAMPLES

Typically a 5.6 μm thick cell, having an anti-parallel rubbed PI alignment layer, is filled on a hotplate at a temperature at which the flexoelectric mixture in the isotropic phase.

After the cell has been filled, the phase transitions including clearing point, and the crystallization behavior are determined using Differential Scanning Calorimetry (DSC) and verified by optical inspection. For optical phase transition measurements, a Mettler FP90 hot-stage controller connected to a FP82 hot-stage is used to control the temperature of the cell. The temperature is increased from ambient temperature at a rate of 5 degrees C. per minute, until the onset of the isotropic phase is observed. The texture change is observed through crossed polarizers using an Olympus BX51 microscope and the respective temperature noted.

Wires are then attached to the ITO electrodes of the cell using indium metal. The cell is secured in a Linkam THMS600 hot-stage connected to a Linkam TMS93 hot-stage controller. The hot-stage is secured to a rotation stage in an Olympus BX51 microscope.

The cell is heated until the liquid crystal is completely isotropic. The cell is then cooled under an applied electric field until the sample is completely nematic. The driving waveform is supplied by a Tektronix AFG3021B arbitrary function generator, which is sent through a Newtons4th LPA400 power amplifier before being applied to the cell. The cell response is monitored with a Thorlabs PDA55 photodiode. Both input waveforms and optical response are measured using a Tektronix TDS 2024B digital oscilloscope.

In order to measure the flexoelectric response of the material, the change in the size of the tilt of the optic axis is measured as a function of increasing voltage. This is achieved by using the equation:

$$tan ϕ = \frac{{P}_{0}}{2 π} \frac{e}{K} {E}_{}$$

wherein φ is the tilt in the optic axis from the original position (i.e. when E=0), E is the applied field, K is the elastic constant (average of K₁ and K₃) and e is the flexoelectric coefficient (where e=e₁+e₃). The applied field is monitored using a HP 34401A multimeter. The tilt angle is measured using the aforementioned microscope and oscilloscope. The undisturbed cholesteric pitch, P₀, is measured using an Ocean Optics USB4000 spectrometer attached to a computer. The selective reflection band is obtained and the pitch determined from the spectral data.

The media shown in the following examples are well suitable for use in ULH-displays. To that end an appropriate concentration of the chiral dopant or dopants used has to be applied in order to achieve a typical cholesteric pitch of 350 to 275 nm.

### Mixture Example 1: Mixture M1

Composition
Compound

| No. | Abbreviation | Conc./% |
|---|---|---|
| 1 | N-PP-ZI-9-Z-GP-F | 15.0 |
| 2 | F-PGI-ZI-9-Z-PUU-N | 20.0 |
| 3 | N-UIUI-9-UU-N | 10.0 |
| 4 | N-PGI-ZI-9-ZGU-F | 15.0 |
| 5 | F-PGI-9-GP-F | 15.0 |
| 6 | N-PZIP-7-PZP-N | 4.0 |
| 7 | N-GIZIP-7-PZG-N | 4.0 |
| 8 | N-PP-ZI-7-GP-N | 5.0 |
| 9 | F-PGI-ZI-5-Z-GP-F | 12.0 |
| Σ | | 100.0 |

This mixture is investigated as described above.

It has the following phase sequence:

| | | | | | | |
|---|---|---|---|---|---|---|
| I | 69° C. | N | 26° C. | N_{TB} | −17° C. | T_{g} |

The mixture M1 shows no crystallisation upon cooling to −50° C.

In cells and in the bulk this mixture is stable at room temperature (>150 hours).

### Comparative Mixture Example 1: Mixture C1 (WO 2013/174481)

Composition
Compound

| No. | Abbreviation | Conc./% |
|---|---|---|
| 1 | R-5011 | 1.8 |
| 2 | N-GIGI-ZI-9-Z-GG-N | 8.5 |
| 3 | N-PGI-ZI-9-Z-GP-N | 8.5 |
| 4 | F-PGI-ZI-9-Z-GP-F | 16.8 |
| 5 | F-UIGI-ZI-9-Z-GP-N | 22.6 |
| 6 | F-PGI-ZI-9-Z-PUU-N | 8.4 |
| 7 | N-GIGI-9-GG-N | 25.1 |
| 8 | N-UIUI-9-UU-N | 8.4 |
| Σ | | 100.0 |

This mixture is investigated as described above.

The mixture exhibits a N_{TB} transition at 30° C. and crystallizes quickly upon further cooling. Consequently, experiments with respect to the elucidation of the N_{TB} phase can only be made at temperatures above 35° C.

### Comparative Mixture Example 2: Mixture C2

Composition
Compound

| No. | Abbreviation | Conc./% |
|---|---|---|
| 1 | F-PGI-ZI-O-9-O-GP-F | 24.45 |
| 2 | F-PGI-ZI-O-9-O-PP-N | 24.45 |
| 3 | F-PGI-ZI-9-Z-GP-F | 24.45 |
| 4 | N-PP-ZI-9-Z-GP-F | 24.45 |
| 5 | R-5011 | 2.20 |
| Σ | | 100.0 |

This mixture is investigated as described above.

It has the following phase sequence:

| | | | | | |
|---|---|---|---|---|---|
| I | 81.7° C. | N | 27.5° C. | N_{TB} | 21° C. |

The mixture C2 shows crystallization upon cooling to room temperature within 30 min.

1. Medium comprising one or more compounds of formula I,
R¹¹-A¹¹-A¹²-(CH₂)ₛ-A¹³-A¹⁴-R¹² I
in a concentration of up to 30% or less,
and one or more compounds of formula II,
R²¹-A²¹-A²²-(A²³)ᵤ-Z²¹—(CH₂)ₜ—Z²²-A²⁴-A²⁵-A²⁶-R²² II
in a concentration of 10% or more,
wherein
R¹¹ to R²² are each independently H, F, Cl, CN, NCS or a straight-chain or branched alkyl group, which may be unsubstituted, mono- or polysubstituted by halogen or CN, it being also possible for one or more non-adjacent CH₂ groups to be replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another,
A¹¹ to A²⁶ are each independently in each occurrence 1,4-phenylene, wherein in addition one or more CH groups may be replaced by N, trans-1,4-cyclo-hexylene in which, in addition, one or two non-adjacent CH₂ groups may be replaced by O and/or S, 1,4-cyclohexenylene, 1,4-bicyclo-(2,2,2)-octylene, piperidine-1,4-diyl, naphthalene-2,6-diyl, decahydro-naphthalene-2,6-diyl, 1,2,3,4-tetrahydro-naphthalene-2,6-diyl, cyclobutane-1,3-diyl, spiro[3.3]heptane-2,6-diyl or dispiro[3.1.3.1]decane-2,8-diyl, it being possible for all these groups to be unsubstituted, mono-, di-, tri- or tetrasubstituted with F, Cl, CN or alkyl, alkoxy, alkylcarbonyl or alkoxycarbonyl groups, wherein one or more H atoms may be substituted by F or Cl,
Z²¹ and Z²² are each independently in each occurrence, —COO—, —OCO—, —O—CO—O—, —OCH₂—, —CH₂O—, —OCF₂—, —CF₂O—, —CH₂CH₂—, —(CH₂)₄—, —CF₂CF₂—, —CH≡CH—, —CF═CF—, —CH═CH—COO—, —OCO—CH═CH— or —C≡C—, optionally substituted with one or more of F, S and/or Si,
s and t denotes an integer from 1 to 15, and
u denotes 0 or 1.

2. Medium according to claim 1, comprising one, two, three or more compounds of formula III,
R³¹-A³¹-A³²-Z³¹—(CH₂)_{z}—Z³²-A³³-A³⁴-R³² III
wherein
R³¹ and R³² have each and independently one of the meanings as given above for R¹¹ in claim 1,
A³¹ to A³⁴ have each and independently one of the meanings as given above for A¹¹ in claim 1,
Z³¹ and Z³² are each independently in each occurrence, —COO—, —OCO—, —O—CO—O—, —OCH₂—, —CH₂O—, —OCF₂—, —CF₂O—, —CH₂CH₂—, —(CH₂)₄—, —CF₂CF₂—, —CHCH—, —CF═CF—, —CH═CH—COO—, —OCO—CH═CH— or —C≡C—, optionally substituted with one or more of F, S and/or Si, and
z denotes an integer from 1 to 15.

3. Medium according to claim 1, comprising one or more compounds of formula IV,
R⁴¹-A⁴¹-A⁴²-Z⁴¹—(CH₂)_{w}-A⁴³-A⁴⁴-R⁴² IV
wherein
R⁴¹ and R⁴² have each and independently one of the meanings as given above for R¹¹ in claim 1,
A³¹ to A³⁴ have each and independently one of the meanings as given above for A¹¹ in claim 1,
Z⁴¹ denotes —O—, —COO—, —OCO—, —O—CO—O—, —OCH₂—, —CH₂O, —CH₂CH₂—, —(CH₂)₄—, —CF₂CF₂—, —CH═CH—, —CF═CF—, —CH═CH—COO—, —OCO—CH═CH— or —C≡C—, optionally substituted with one or more of F, S and/or Si, and
w denotes an integer from 1 to 15.

4. Medium according to claim 1, comprising one, two, three or more compounds of formula V,
R⁵¹-A⁵¹-Z⁵¹-A⁵²-(Z⁵²-A⁵³)ₗ-(CH₂)ₚ-(A⁴-Z⁵³-)ₘA⁵⁵-Z⁵⁴-A⁵⁶-R⁵² V
wherein
R⁵¹ and R⁵² have each and independently one of the meanings as given above for R¹¹ in claim 1,
A⁵¹ to A⁵⁶ have each and independently one of the meanings as given above for A¹¹ in claim 1,
Z⁵¹ to Z⁵⁴ each and independently denotes —COO—, —OCO—, —O—CO—O—, —OCH₂—, —CH₂O—, —CH₂CH₂—, —(CH₂)₄—, —OCF₂—, —CF₂O—, —CF₂CF₂—, —CH═CH—, —CF═CF—, —CH═CH—COO—, —OCO—CH═CH— or —C≡C—, optionally substituted with one or more of F, S and/or Si, or a single bond, with the proviso that at least one of Z⁵¹ to Z⁵⁴ is not a single bond,
p denotes an integer from 1 to 15, and
l and m each and independently denotes 0 or 1.

5. Medium according to claim 1, comprising one or more chiral dopants.

6. Medium according to claim 1, comprising one or more additives selected from the following formula VIII, 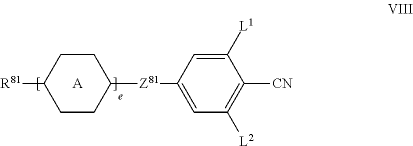
wherein
R⁸¹ is alkyl, alkoxy, alkenyl or alkenyloxy with up to 12 C atoms, 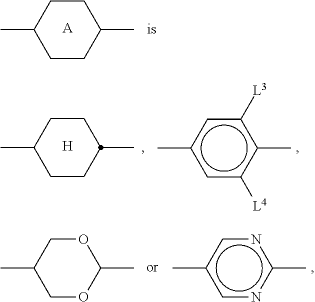
L¹ to L⁴ are each independently H or F,
Z⁸¹ is —COO—, —CH₂CH₂— or a single bond, and
e is 1 or 2.

7. Medium according to claim 1, characterised in that the amount of compounds of formula I in the medium as a whole is up to 27% or less.

8. Medium according to claim 1, characterized in that the amount of compounds of formula II in the medium as a whole is at least 15% or more.

9. Medium according to claim 1, characterized in that the amount of compounds of formula III in the medium as a whole is from 10 to 70%.

10. Medium according to claim 1, characterized in that the amount of compounds of formula IV in the medium as a whole is from 1 to 15%.

11. Medium according to claim 1, characterized in that the amount of compounds of formula V in the medium as a whole is from 1 to 20%.

12. Medium according to claim 1, characterized in that the amount of chiral compounds in the medium as a whole is from 1 to 15%.

13. Medium according to claim 1, characterized in that the amount of compounds of formula VIII in the medium as a whole is from 1 to 20%.

14. Process for the production of a medium according to claim 1, said process comprising the steps of mixing up to 30% or less of one or more compounds of formula I,
R¹¹-A¹¹-A¹²-(CH₂)ₛ-A¹³-A¹⁴-R¹² I
with at least 10% or more of one or more compounds of formula II,
R²¹-A²¹-A²²-(A²³)ᵤ-Z²¹—(CH₂)ₜ—Z²²-A²⁴-A²⁵-A²⁶-R²² II
wherein R¹¹ to R²², A¹¹ to A²⁶, Z²¹, Z²², s, t, and u have one the meanings as given above in claim 1, and optionally with at least one compound selected from compounds of formula III, and/or IV, and/or V.

15. (canceled)

16. Liquid crystal device comprising a medium according to claim 1.

17. Liquid crystal device according to claim 16, characterized in that it is a flexoelectric device.
